(19) United States
(12) Patent Application Publication
(10) Pub. No.: US 2026/0023173 A1
(43) Pub. Date: Jan. 22, 2026

(54) TARGET TRACKING DEVICE AND TARGET TRACKING METHOD

(71) Applicant: Mitsubishi Electric Corporation, Tokyo (JP)

(72) Inventors: Hiroshi KAMEDA, Tokyo (JP); Toshihiro ITO, Tokyo (JP)

(73) Assignee: Mitsubishi Electric Corporation, Tokyo (JP)

(21) Appl. No.: 19/286,948

(22) Filed: Jul. 31, 2025

Related U.S. Application Data
(63) Continuation of application No. PCT/JP2023/013038, filed on Mar. 30, 2023.

(51) Int. Cl. G01S 13/72

(52) U.S. Cl. CPC G01S 13/723

(57) ABSTRACT

This target tracking device includes an initial value calculating unit that acquires position observation information at two different sampling times from a sensor, and calculates an initial value of a smoothed value including a position vector of the target and a velocity vector of the target as an initial value of the smoothed value. In addition, the target tracking device includes a smoothing unit that performs estimation processing of estimating a smoothed value and a prediction value, and a prediction unit that predicts a future state of the target by using an initial value of the smoothed value calculated or a smoothed value and outputs a prediction value to the smoothing unit as a prediction value to be used by the smoothing unit for next estimation processing.

### CROSS REFERENCE TO RELATED APPLICATION

This application is a Continuation of PCT International Application No. PCT/JP2023/013038, filed on Mar. 30, 2023, which is hereby expressly incorporated by reference into the present application.

### TECHNICAL FIELD

The present disclosure relates to a target tracking device and a target tracking method.

### BACKGROUND ART

There is a target tracking device that tracks a target by predicting each of the position of the target and the velocity of the target.

As such a target tracking device, Non-Patent Literature 1, for example, discloses a target tracking device that predicts a target position or the like using a tracking filter.

### CITATION LIST

### Non-Patent Literature

Non-Patent Literature 1: “A Cost-Effective Tracking Algorithm for Hypersonic Glide Vehicle Maneuver Based on Modified Aerodynamic Model”, June 2016, Applied Sciences, [searched on Dec. 27, 2022], Internet <URL: http://www.mdpi.com/journal/applsci>

### SUMMARY OF INVENTION

### Technical Problem

In the target tracking device disclosed in Non-Patent Literature 1, an initial value of a smoothed value including a target position vector and a target velocity vector needs to be set in the tracking filter as an initial value of a smoothed value indicating the state of the target in order to predict the position or the like of the target. When the initial value of the smoothed value greatly deviates from the original smoothed value, the prediction accuracy of the position or the like by the target tracking device deteriorates. This leads to a problem that the target tracking device may not be able to track the target.

The present disclosure has been made to solve the above problems, and an object of the present disclosure is to obtain a target tracking device that can suppress deterioration of prediction accuracy due to a large deviation of an initial value of a smoothed value from an original smoothed value.

### Solution to Problem

The target tracking device according to the present disclosure includes a processor; and a memory storing a program, upon executed by the processor, to perform a process: to acquire position observation information indicating target observation positions at two different sampling times from a sensor that observes a position of a target, and calculate an initial value of a smoothed value including a position vector of the target and a velocity vector of the target as an initial value of a smoothed value indicating a state of the target on the basis of the position observation information. The process of the target tracking device also includes: to perform estimation processing of estimating the smoothed value indicating the state of the target using the position observation information output from the sensor and a prediction value indicating the state of the target; and to predict a future state of the target using the initial value of the smoothed value calculated or a smoothed value estimated, and output a prediction value indicating a result of predicting the future state of the target as a prediction value to be used for next estimation processing, wherein the process includes: to transform a coordinate system of the initial value of the smoothed value calculated or a coordinate system of the smoothed value estimated into a body coordinate system of the target; to predict a future state of the target using an initial value of the body coordinate system that has been transformed or a smoothed value of the body coordinate system that has been transformed, and output a prediction value indicating a prediction result of predicting the future state of the target; and to transform a coordinate system of the prediction value output into a north-east-up coordinate system, and the process acquires, as a prediction value to be used for next estimation processing, a prediction value of the north-east-up coordinate system that has been transformed, and performs estimation processing of estimating a smoothed value indicating the state of the target using the position observation information output from the sensor and the prediction value of the north-east-up coordinate system.

### Advantageous Effects of Invention

According to the present disclosure, it is possible to suppress deterioration of prediction accuracy due to a large deviation of an initial value of a smoothed value from an original smoothed value.

### BRIEF DESCRIPTION OF DRAWINGS

FIG. 1 is a configuration diagram illustrating a target tracking device according to a first embodiment.

FIG. 2 is a hardware configuration diagram illustrating hardware of the target tracking device according to the first embodiment.

FIG. 3 is a hardware configuration diagram of a computer in a case where the target tracking device is implemented by software, firmware, or the like.

FIG. 4 is a flowchart illustrating a target tracking method which is a processing procedure performed by the target tracking device.

FIG. 5 is a configuration diagram illustrating a target tracking device according to a second embodiment.

FIG. 6 is a hardware configuration diagram illustrating hardware of the target tracking device according to the second embodiment.

FIG. 7 is an explanatory diagram illustrating a constant aerodynamic vector an.

FIG. 8 is a flowchart illustrating a target tracking method which is a processing procedure performed by the target tracking device.

### DESCRIPTION OF EMBODIMENTS

In order to describe the present disclosure in more detail, embodiments for carrying out the present disclosure will now be described with reference to the accompanying drawings.

### First Embodiment

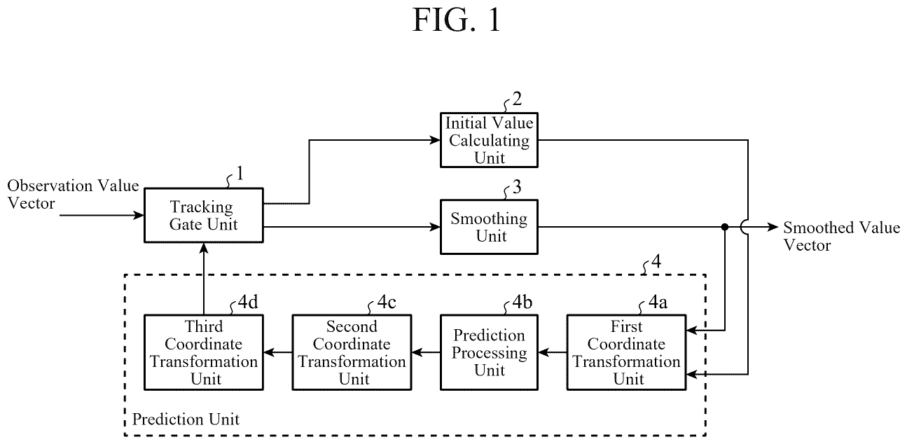

FIG. 1 is a configuration diagram illustrating a target tracking device according to the first embodiment.

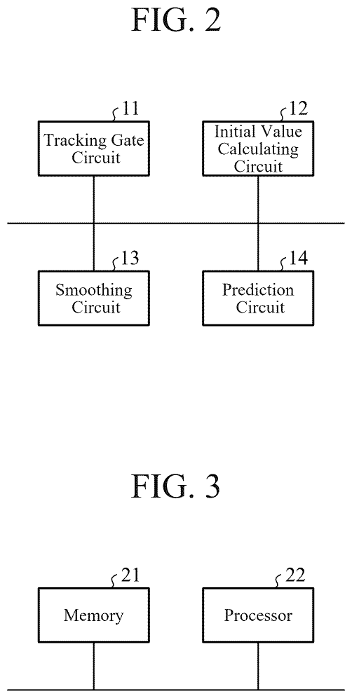

FIG. 2 is a hardware configuration diagram illustrating hardware of the target tracking device according to the first embodiment.

The target tracking device illustrated in FIG. 1 includes a tracking gate unit 1, an initial value calculating unit 2, a smoothing unit 3, and a prediction unit 4.

The tracking gate unit 1 is implemented by a tracking gate circuit 11 illustrated in FIG. 2.

The tracking gate unit 1 acquires position observation information indicating a target observation position from a sensor (not illustrated) that observes the position of a target.

The tracking gate unit 1 outputs, for example, the position observation information at the first sampling time and the position observation information at the second sampling time to the initial value calculating unit 2 as position observation information indicating the target observation positions at two different sampling times.

Regarding the position observation information at the third and subsequent sampling times, the tracking gate unit 1 outputs the position observation information to the smoothing unit 3 only when the target observation position indicated by the position observation information is present in a tracking gate.

When the target observation position indicated by the position observation information is present in the tracking gate, the tracking gate unit 1 outputs a prediction value predicted last time by the prediction unit 4 and a prediction error covariance matrix calculated by the prediction unit 4 to the smoothing unit 3.

Here, the tracking gate unit 1 outputs the position observation information at the first sampling time and the position observation information at the second sampling time to the initial value calculating unit 2 as the position observation information indicating the target observation positions at two different sampling times. However, this is merely an example, and the tracking gate unit 1 may output, for example, the position observation information at the second sampling time and the position observation information at the third sampling time to the initial value calculating unit 2, or may output the position observation information at the third sampling time and the position observation information at the fourth sampling time to the initial value calculating unit 2, as the position observation information indicating the target observation positions at two different sampling times.

The initial value calculating unit 2 is implemented by an initial value calculating circuit 12 illustrated in FIG. 2.

The initial value calculating unit 2 acquires, for example, the position observation information at the first sampling time and the position observation information at the second sampling time from the tracking gate unit 1.

The initial value calculating unit 2 calculates an initial value of a smoothed value including each of a target position vector and a target velocity vector as an initial value of a smoothed value indicating the state of the target on the basis of the position observation information at the first sampling time and the position observation information at the second sampling time.

In addition, the initial value calculating unit 2 calculates an initial value of a smoothing error covariance matrix on the basis of an observation error covariance matrix to be described later and a drive noise error covariance matrix to be described later.

The initial value calculating unit 2 outputs each of the initial value of the smoothed value and the initial value of the smoothing error covariance matrix to the prediction unit 4.

The smoothing unit 3 is implemented by a smoothing circuit 13 illustrated in FIG. 2.

The smoothing unit 3 acquires the position observation information, the prediction value, and the prediction error covariance matrix from the tracking gate unit 1.

The smoothing unit 3 performs estimation processing of estimating a smoothed value indicating the state of the target using the position observation information, the prediction value, and the prediction error covariance matrix.

Specifically, the smoothing unit 3 estimates, as the smoothed value, a smoothed value vector including a position vector of the target, a velocity vector of the target, and an aerodynamic coefficient of the target.

In order for the target tracking device illustrated in FIG. 1 to track the target, the position vector of the target and the velocity vector of the target are necessary as smoothed values estimated by the smoothing unit 3. When the smoothing unit 3 does not estimate the aerodynamic coefficient of the target as the smoothed value estimated by the smoothing unit 3, the target tracking accuracy slightly decreases, but the tracking of the target is possible even if the smoothing unit 3 does not estimate the aerodynamic coefficient of the target.

The smoothing unit 3 also calculates a smoothing error covariance matrix on the basis of the prediction error covariance matrix.

The smoothing unit 3 outputs each of the smoothed value and the smoothing error covariance matrix to the prediction unit 4.

The prediction unit 4 is implemented by a prediction circuit 14 illustrated in FIG. 2.

The prediction unit 4 includes a first coordinate transformation unit 4a, a prediction processing unit 4b, a second coordinate transformation unit 4c, and a third coordinate transformation unit 4d.

The prediction unit 4 acquires the initial value of the smoothed value from the initial value calculating unit 2 or the smoothed value from the smoothing unit 3.

The prediction unit 4 predicts the future state of the target using the initial value of the smoothed value or the smoothed value.

The prediction unit 4 outputs a prediction value indicating a result of predicting the future state of the target to the tracking gate unit 1 as a prediction value used by the smoothing unit 3 for the next estimation processing.

Further, the prediction unit 4 acquires the initial value of the smoothing error covariance matrix from the initial value calculating unit 2 or the smoothing error covariance matrix from the smoothing unit 3.

The prediction unit 4 calculates a prediction error covariance matrix using the initial value of the smoothing error covariance matrix or the smoothing error covariance matrix.

The prediction unit 4 outputs the calculated prediction error covariance matrix to the tracking gate unit 1 as a prediction error covariance matrix used by the smoothing unit 3 for the next estimation processing.

The first coordinate transformation unit 4a acquires the initial value of the smoothed value from the initial value calculating unit 2 or the smoothed value from the smoothing unit 3.

The first coordinate transformation unit 4a transforms the coordinate system of the initial value of the smoothed value or the coordinate system of the smoothed value from a north-east-up coordinate system to a body coordinate system of the target.

The first coordinate transformation unit 4a outputs the initial value of the smoothed value of the body coordinate system or the smoothed value of the body coordinate system to the prediction processing unit 4b.

Further, the first coordinate transformation unit 4a acquires the initial value of the smoothing error covariance matrix from the initial value calculating unit 2 or the smoothing error covariance matrix from the smoothing unit 3.

The first coordinate transformation unit 4a transforms the coordinate system of the initial value of the smoothing error covariance matrix or the coordinate system of the smoothing error covariance matrix from the north-east-up coordinate system to the body coordinate system of the target.

The first coordinate transformation unit 4a outputs the initial value of the smoothing error covariance matrix of the body coordinate system or the smoothing error covariance matrix of the body coordinate system to the prediction processing unit 4b.

The prediction processing unit 4b acquires the initial value of the smoothed value of the body coordinate system or the smoothed value of the body coordinate system from the first coordinate transformation unit 4a.

The prediction processing unit 4b predicts the future state of the target using the initial value of the smoothed value of the body coordinate system or the smoothed value of the body coordinate system.

The prediction processing unit 4b outputs a prediction value indicating the result of predicting the future state of the target to the second coordinate transformation unit 4c.

In addition, the prediction processing unit 4b acquires the initial value of the smoothing error covariance matrix of the body coordinate system or the smoothing error covariance matrix of the body coordinate system.

The prediction processing unit 4b calculates a prediction error covariance matrix using the initial value of the smoothing error covariance matrix of the body coordinate system or the smoothing error covariance matrix of the body coordinate system.

The prediction processing unit 4b outputs the prediction error covariance matrix of the body coordinate system to the second coordinate transformation unit 4c.

The second coordinate transformation unit 4c acquires each of the prediction value of the body coordinate system and the prediction error covariance matrix of the body coordinate system from the prediction processing unit 4b.

The second coordinate transformation unit 4c transforms the coordinate system of the prediction value from the body coordinate system to the north-east-up coordinate system.

The second coordinate transformation unit 4c outputs each of the prediction value of the north-east-up coordinate system and the prediction error covariance matrix of the body coordinate system to the third coordinate transformation unit 4d.

The third coordinate transformation unit 4d acquires each of the prediction value of the north-east-up coordinate system and the prediction error covariance matrix of the body coordinate system from the second coordinate transformation unit 4c.

The third coordinate transformation unit 4d transforms the coordinate system of the prediction error covariance matrix from the body coordinate system to the north-east-up coordinate system, and adds drive noise to the transformed prediction error covariance matrix.

The third coordinate transformation unit 4d outputs each of the prediction value of the north-east-up coordinate system and the prediction error covariance matrix with drive noise to the tracking gate unit 1.

In the target tracking device illustrated in FIG. 1, the prediction unit 4 includes the third coordinate transformation unit 4d. When the prediction unit 4 does not include the third coordinate transformation unit 4d, the accuracy of tracking the target slightly decreases, but the target can be tracked even if the prediction unit 4 does not include the third coordinate transformation unit 4d. In a case where the prediction unit 4 does not include the third coordinate transformation unit 4d, the second coordinate transformation unit 4c transforms the coordinate system of the prediction error covariance matrix from the body coordinate system to the north-east-up coordinate system, and outputs the transformed prediction error covariance matrix to the tracking gate unit 1.

In FIG. 1, it is assumed that each of the tracking gate unit 1, the initial value calculating unit 2, the smoothing unit 3, and the prediction unit 4, which are components of the target tracking device, is implemented by dedicated hardware as illustrated in FIG. 2. That is, it is assumed that the target tracking device is implemented by the tracking gate circuit 11, the initial value calculating circuit 12, the smoothing circuit 13, and the prediction circuit 14.

Each of the tracking gate circuit 11, the initial value calculating circuit 12, the smoothing circuit 13, and the prediction circuit 14 is, for example, a single circuit, a composite circuit, a programmed processor, a parallel programmed processor, an application specific integrated circuit (ASIC), a field-programmable gate array (FPGA), or a combination of some of these circuits.

The components of the target tracking device are not limited to be implemented by dedicated hardware, and the target tracking device may be implemented by software, firmware, or a combination of software and firmware.

Software or firmware is stored in a memory of a computer as a program. The computer means hardware that executes the program, and may be, for example, a central processing unit (CPU), a graphics processing unit (GPU), a central processor, a processing unit, a computing unit, a microprocessor, a microcomputer, a processor, or a digital signal processor (DSP).

FIG. 3 is a hardware configuration diagram of a computer in a case where the target tracking device is implemented by software, firmware, or the like.

In a case where the target tracking device is implemented by software, firmware, or the like, a program for causing the computer to execute the processing procedures of the tracking gate unit 1, the initial value calculating unit 2, the smoothing unit 3, and the prediction unit 4 is stored in a memory 21. Then, a processor 22 of the computer executes the program stored in the memory 21.

Further, FIG. 2 shows an example in which each of the components of the target tracking device is implemented by dedicated hardware, and FIG. 3 shows an example in which the target tracking device is implemented by software, firmware, or the like. However, this is merely an example, and some components of the target tracking device may be implemented by dedicated hardware, and the remaining components may be implemented by software, firmware, or the like.

Next, the operation principle of the target tracking device illustrated in FIG. 1 will be described.

In the target tracking device illustrated in FIG. 1, it is assumed that a state vector Xₖ of a tracking filter is expressed as Expression (1) described below.

An observation value vector Zₖ that is the position observation information given from the sensor to the target tracking device is expressed as Expression (2) described below.

$${X}_{k} = {[ \begin{matrix}{x}_{k} & {y}_{k} & {z}_{k} & {\dot{x}}_{k} & {\dot{y}}_{k} & {\dot{z}}_{k} & {α}_{{L}_{1}} & {α}_{{L}_{2}} & β\end{matrix} ]}^{T} \qquad ( 1 )$$

$${Z}_{k} = {[ \begin{matrix}{x}_{k} & {y}_{k} & {z}_{k}\end{matrix} ]}^{T} \qquad ( 2 )$$

In Expressions (1) and (2), T is a mathematical symbol indicating transposition.

xₖ, yₖ, and zₖ included in the state vector Xk are position vectors indicating positions of the target, and xk dot, yk dot, and zk dot included in the state vector Xk are velocity vectors indicating velocities of the target. In the text of the specification, the symbol “·” cannot be written above the characters because of the electronic application, so the character with dot is written like xₖ dot.

Each of the position vectors xk, yk, and zk and the velocity vectors xk dot, yk dot, and zk dot is represented in the north-east-up coordinate system.

α_{L1} included in the state vector Xₖ corresponds to an aerodynamic coefficient related to a component for raising a fuselage that is the target by lift. Specifically, α_{L1} is obtained by dividing the value of (aerodynamic coefficient)×(reference area) by the mass. Hereinafter, it is assumed that α_{L1} is an aerodynamic coefficient of the target for convenience of description.

α_{L2} included in the state vector Xₖ corresponds to an aerodynamic coefficient related to a component for moving the fuselage that is the target in the water level direction. In the following description, α_{L2} is also defined as an aerodynamic coefficient of the target.

β included in the state vector Xₖ corresponds to an aerodynamic coefficient related to air resistance. In the following description, β is also defined as an aerodynamic coefficient of the target.

The aerodynamic coefficients α_{L1} , α_{L2} , and β are expressed in the body coordinate system of the target.

Therefore, the coordinate system of the state vector Xₖ is defined in a form in which the north-east-up coordinate system and the body coordinate system are mixed.

The state vector of the tracking filter can also be expressed as Yₖ as represented by Expression (3) described below.

$${Y}_{k} = {[ \begin{matrix}{x}_{k} & {y}_{k} & {z}_{k} & {V}_{k} & {γ}_{k} & {η}_{k} & {α}_{{L}_{1}} & {α}_{{L}_{2}} & β\end{matrix} ]}^{T} \qquad ( 3 )$$

The state vector Xₖ represented by Expression (1) and the state vector Yₖ represented by Expression (3) are different from each other in the fourth to sixth terms.

Vₖ included in the state vector Yₖ is expressed as Expression (4) described below. γₖ included in the state vector Yₖ is expressed as Expression (5) described below. ηₖ included in the state vector Yₖ is expressed as Expression (6) described below.

$${V}_{k} = \sqrt{{\dot{x}}_{k}^{2} + {\dot{y}}_{k}^{2} + {\dot{z}}_{k}^{2}} \qquad ( 4 )$$

$${γ}_{k} = {tan}^{- 1} \frac{{\dot{z}}_{k}}{\sqrt{{\dot{x}}_{k}^{2} + {\dot{y}}_{k}^{2}}} \qquad ( 5 )$$

$${η}_{k} = {tan}^{- 1} \frac{{\dot{y}}_{k}}{{\dot{x}}_{k}} \qquad ( 6 )$$

In the target tracking device illustrated in FIG. 1, the relationship between the state vector Xₖ represented by Expression (1) and the state vector Yₖ represented by Expression (3) is expressed as Expression (7) described below.

$${Y}_{k} = g ( {X}_{k} ) \qquad ( 7 )$$

In Expression (7), g() is a function for converting the state vector Xₖ into the state vector Yₖ.

In the target tracking device illustrated in FIG. 1, it is assumed that a motion model of the target is expressed by a first-order differential equation as expressed by Expression (8) described below. Expression (9) described below indicates each of the first-order differential value of Vₖ, the first-order differential value of γₖ, and the first-order differential value of ηₖ included in the state vector Yₖ.

$${\dot{Y}}_{k} = f ( {Y}_{k} ) \qquad ( 8 )$$

$$[ \begin{matrix}{\dot{V}}_{k} \\ {\dot{γ}}_{k} \\ {\dot{η}}_{k}\end{matrix} ] = [ \begin{matrix}- D - g sin {γ}_{k} \\ \frac{L - g cos {γ}_{k}}{{V}_{k}} + \frac{{V}_{k} cos {γ}_{k}}{{r}_{k}} \\ \frac{Y}{{V}_{k} cos {γ}_{k}}\end{matrix} ] \qquad ( 9 )$$

In Expression (9), g represents gravitational acceleration. γₖ is expressed as Expression (10) described below.

L is the lift acting in the vertical direction of the body axis and is expressed as Expression (11) described below.

Y is the lift acting in the horizontal direction of the body axis and is expressed as Expression (12) described below.

D is a component of an aerodynamic force due to a drag force acting in a direction opposite to the velocity vector of the target, and is expressed as Expression (13) described below.

$${r}_{k} = \sqrt{{x}_{k}^{2} + {y}_{k}^{2} + {z}_{k}^{2}} \qquad ( 10 )$$

$$L = \frac{1}{2} ρ {V}_{k}^{2} {α}_{{L}_{1}} \qquad ( 11 )$$

$$Y = \frac{1}{2} ρ {V}_{k}^{2} {α}_{{L}_{2}} \qquad ( 12 )$$

$$D = ρ {V}_{k}^{2} β \qquad ( 13 )$$

In Expressions (11) to (13), ρ is the air density and varies as indicated in Expression (14) described below depending on the altitude h of the target.

$$ρ = {ρ}_{0} exp ( - \frac{h}{{h}_{s}} ) \qquad ( 14 )$$

In Expression (14), ρ₀ represents the atmospheric density of the ground surface.

$${ρ}_{0} = 1.3906 [ kg / {m}^{3} ] .$$

hₛ represents the height of the scale. hₛ=7.163×10³ [m].

In Non-Patent Literature 1, Expressions (11) to (13) are described on the basis of each of the bank angle of the fuselage and the angle of attack of the fuselage, which are attitude information of the fuselage.

The attitude information of the fuselage is unknown information. Therefore, in the target tracking device illustrated in FIG. 1, the state vector Yₖ is defined on the premise that the aerodynamic coefficient α_{L1}, the aerodynamic coefficient α_{L2}, and the aerodynamic coefficient β, which are elements of the state vector Yₖ include the lift L, the lift Y, and the component D, respectively.

When the coordinate system of the motion model of the target indicated by Expression (8) is transformed to the north-east-up coordinate system on the basis of the relationship between the state vector Xₖ and the state vector Yₖ represented by Expression (7), the motion model of the target is expressed as Expression (15) described below.

$${\dot{X}}_{k} = {g}^{- 1} ( f ( {Y}_{k} ) ) + {w}_{k} \qquad ( 15 )$$

In Expression (15), Wₖ is a drive noise vector.

In the target tracking device illustrated in FIG. 1, it is assumed that the drive noise vector Wₖ has a property as represented by Expression (16) described below.

Expression (17) described below is a drive noise error covariance matrix.

$$E [ {w}_{k} ] = 0 \qquad ( 16 )$$

$$E [ {w}_{k} {w}_{k}^{T} ] = {Q}_{k} \qquad ( 17 )$$

When a state quantity change between the two sampling times Δt is discretized by terminating the state quantity change at the first order of the Taylor expansion, the motion model of the target represented by Expression (8) is expressed as Expression (18) described below.

$${Y}_{k + 1} = {Y}_{k} + f ( {Y}_{k} ) Δ t \qquad ( 18 )$$

When the observation value vector Zₖ given from the sensor to the target tracking device is expressed as Expression (2) and the coordinate system of the observation value vector Zₖ is expressed by the north-east-up coordinate system, the observation model of the target can be defined as Expression (19) described below.

$${Z}_{k} = {HX}_{k} + {V}_{k} \qquad ( 19 )$$

$$H = [ {I}_{3 \times 3} , {0}_{3 \times 6} ] \qquad ( 20 )$$

In Expression (19), H represents an observation matrix, and Vₖ represents an observation noise vector.

The observation noise vector Vₖ is assumed to have a property as represented by Expression (21) described below. Expression (22) described below represents an observation error covariance matrix Rₖ.

$$E [ {V}_{k} ] = 0 \qquad ( 21 )$$

$$E [ {V}_{k} {V}_{k}^{T} ] = {R}_{k} \qquad ( 22 )$$

$${R}_{k} = [ \begin{matrix}cos E sin Az & - r sin E sin A & r cos E cos A \\ cos E cos A & - r sin E cos A & - r cos E sin A \\ sin E & r cos E & 0\end{matrix} ] diag \qquad ( 23 )$$

$${( [ \begin{matrix}{σ}_{r}^{2} & {σ}_{E}^{2} & {σ}_{Az}^{2} ]\end{matrix} ) [ \begin{matrix}cos E sin Az & - r sin E sin A & r cos E cos A \\ cos E cos A & - r sin E cos A & - r cos E sin A \\ sin E & r cos E & 0\end{matrix} ]}^{T}$$

In Expression (23), r is the distance from a radar device to the target, E is an elevation angle of the target with respect to the radar device, and A is an azimuth angle of the target with respect to the radar device.

The processing of the tracking filter based on the state vector, the motion model, and the observation model is performed as follows.

First, an initial value X_{0,1} of the smoothed value vector is calculated from an observation value vector Z₀ which is the position observation information at the first sampling time t₀ and an observation value vector Z₁ at the second sampling time t₁ as expressed by Expression (24) described below. The observation value vectors Z₁ and Z₂ are observation value vectors of the north-east-up coordinate system.

$${X}_{0 , 1} = {[ \begin{matrix}{Z}_{1} & \frac{{Z}_{1} - {Z}_{0}}{Δ t}\end{matrix} ]}^{T} \qquad ( 24 )$$

In Expression (24), Δt represents a sampling interval between the sampling time to and the sampling time t₁.

An initial value P_{0,1} of the smoothing error covariance matrix is expressed as Expression (25) described below. Each of Expressions (24) and (25) is applied to six dimensions up to the position and velocity of the target. In the initial value P_{0,1} of the smoothing error covariance matrix, P_{0,1(+)}(7:9,7:9) corresponds to terms of an aerodynamic coefficient of the 7th to 9th dimensions, and an error covariance matrix Qₐₑᵣₒ of drive noise is given.

$${P}_{0 , 1} = [ \begin{matrix}{R}_{1} & \frac{{R}_{1}}{Δ t} \\ \frac{{R}_{1}^{T}}{Δ t} & {R}_{1} + \frac{{R}_{0}}{Δ {t}^{2}} + \frac{{Q}_{k} ( 1 : 3 , 1 : 3 )}{Δ {t}^{2}} + 2 \frac{{Q}_{1} ( 1 : 3 , 4 : 6 )}{Δ t}\end{matrix} ] \qquad ( 25 )$$

The error covariance matrix Qₐₑᵣₒ of the drive noise is expressed as Expression (29) described below.

$${Q}_{k} = [ \begin{matrix}{Q}_{acc} & {0}_{6 \times 3} \\ {0}_{3 \times 6} & {Q}_{aero}\end{matrix} ] \qquad ( 26 )$$

$${Q}_{acc} = [ \begin{matrix}\frac{Δ {t}^{3}}{3} S & \frac{Δ {t}^{2}}{2} S \\ \frac{Δ {t}^{2}}{2} S & Δ tS\end{matrix} ] \qquad ( 27 )$$

$$S = diag [ \begin{matrix}{σ}_{accx}^{2} δ t & {σ}_{accy}^{2} δ t & {σ}_{accz}^{2} δ t\end{matrix} ] \qquad ( 28 )$$

$${Q}_{aero} = diag [ \begin{matrix}{σ}_{{α}_{{L}_{1}}}^{2} & {σ}_{{α}_{{L}_{2}}}^{2} & {σ}_{β}^{2}\end{matrix} ] \qquad ( 29 )$$

In Expression (28), σ²_{accx}, σ²_{accy}, and σ²_{accz} represent the variance of system noise acting on each of the position and velocity of the target. In particular, σ²_{accx} is a parameter indicating acceleration fluctuation in the x coordinate, σ²_{accy} is a parameter indicating acceleration fluctuation in the y coordinate, and σ²_{accz} is a parameter indicating acceleration fluctuation in the z coordinate.

In Expression (29), each of σ²_{αL1}, σ²_{αL2}, and σ²_{β} represents the variance of system noise acting on the aerodynamic force. In particular, σ²_{αL1} is a parameter indicating the fluctuation of the aerodynamic force in the x coordinate, α²_{αL2} is a parameter indicating the fluctuation of the aerodynamic force in the y coordinate, and σ²_{β} is a parameter indicating the fluctuation of the aerodynamic force in the z coordinate.

The smoothed value vector X_{k|k} of the north-east-up coordinate system is transformed into a smoothed value vector Y_{k|k} of the body coordinate system in accordance with Expression (7).

The smoothing error covariance matrix P_{k|k} in accordance with Expression (25) or the smoothing error covariance matrix P_{k|k} in accordance with Expression (67) described later is transformed into a smoothing error covariance matrix V_{k|k} of the body coordinate system in accordance with Expression (30) described below.

$${V}_{k \vert k} = Ψ {P}_{k \vert k} {Ψ}^{T} \qquad ( 30 )$$

$$Ψ = [ \begin{matrix}{I}_{3 \times 3} & {0}_{3 \times 3} & {0}_{3 \times 3} \\ {0}_{3 \times 3} & A & {0}_{3 \times 3} \\ {0}_{3 \times 3} & {0}_{3 \times 3} & {I}_{3 \times 3}\end{matrix} ] \qquad ( 31 )$$

$$A = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] \qquad ( 32 )$$

The matrix A is a Jacobian matrix.

$${a}_{11} = \frac{{\dot{x}}_{k}}{{V}_{k}} \qquad ( 33 )$$

$${a}_{12} = \frac{{\dot{y}}_{k}}{{V}_{k}} \qquad ( 34 )$$

$${a}_{13} = \frac{{\dot{z}}_{k}}{{V}_{k}} \qquad ( 35 )$$

$${a}_{21} = \frac{- {\dot{x}}_{k} {\dot{z}}_{k}}{{V}_{k}^{3} ( \frac{{\dot{z}}_{k}}{\sqrt{{\dot{x}}_{k}^{2} + {\dot{y}}_{k}^{2}}} + 1 )} \qquad ( 36 )$$

$${a}_{22} = \frac{- {\dot{y}}_{k} {\dot{z}}_{k}}{{V}_{k}^{3} ( \frac{{\dot{z}}_{k}}{\sqrt{{\dot{x}}_{k}^{2} + {\dot{y}}_{k}^{2}}} + 1 )} \qquad ( 37 )$$

$${a}_{23} = \frac{1}{\sqrt{{\dot{x}}_{k}^{2} + {\dot{y}}_{k}^{2}} ( \frac{{\dot{z}}_{k}}{\sqrt{{\dot{x}}_{k}^{2} + {\dot{y}}_{k}^{2}}} + 1 )} \qquad ( 38 )$$

$${a}_{31} = \frac{- {\dot{y}}_{k}}{{\dot{x}}_{k}^{2} + {\dot{y}}_{k}^{2}} \qquad ( 39 )$$

$${a}_{32} = \frac{{\dot{x}}_{k}}{{\dot{x}}_{k}^{2} + {\dot{y}}_{k}^{2}} \qquad ( 40 )$$

$${a}_{33} = 0 \qquad ( 41 )$$

The prediction value vector Y_{k+1|k} of the body coordinate system is calculated in accordance with Expression (42) described below. In addition, the prediction error covariance matrix V_{k+1|k} of the body coordinate system is calculated in accordance with Expression (43) described below.

$${Y}_{k + 1 \vert k} = {Y}_{k \vert k} + f ( {Y}_{k \vert k} ) Δ t \qquad ( 42 )$$

$${V}_{k + 1 \vert k} = {Φ}_{k} {V}_{k \vert k} {Φ}_{k}^{T} \qquad ( 43 )$$

$${Φ}_{k} = {I}_{9 \times 9} + \frac{\partial f ( Y )}{\partial Y} Δ t \qquad ( 44 )$$

$$\frac{\partial f ( Y )}{\partial Y} = [ \begin{matrix}0 & 0 & 0 & cos γcosη & - V sin γcosη & - V cos γsinη & 0 & 0 & 0 \\ 0 & 0 & 0 & cos γsinη & - V sin γsinη & V cos γcosη & 0 & 0 & 0 \\ 0 & 0 & 0 & sin γ & V cos γ & 0 & 0 & 0 & 0 \\ 0 & 0 & 0 & - ρ V β & - g cos γ & 0 & 0 & 0 & {c}_{49} \\ 0 & 0 & 0 & {c}_{54} & {c}_{55} & 0 & {c}_{57} & 0 & 0 \\ 0 & 0 & 0 & {c}_{64} & {c}_{65} & 0 & 0 & {c}_{68} & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0\end{matrix} ] \qquad ( 45 )$$

$${c}_{49} = - \frac{1}{2} ρ {V}^{2} \qquad ( 46 )$$

$${c}_{54} = \frac{1}{2} {ρα}_{{L}_{1}} + \frac{g}{{V}^{2}} cos γ \qquad ( 47 )$$

$${c}_{55} = \frac{g}{V} sin γ \qquad ( 48 )$$

$${c}_{57} = \frac{1}{2} ρ V \qquad ( 49 )$$

$${c}_{64} = \frac{1}{2} {ρα}_{{L}_{1}} / cos γ \qquad ( 50 )$$

$${c}_{65} = \frac{1}{2} {ρα}_{{L}_{2}} \frac{sin γ}{{cos}^{2} γ} \qquad ( 51 )$$

$${c}_{68} = \frac{\frac{1}{2} ρ V}{cos γ} \qquad ( 52 )$$

The prediction value vector Y_{k+1|k} of the body coordinate system is transformed into a prediction value vector X_{k+1|k} of the north-east-up coordinate system in accordance with Expression (53) described below.

The prediction error covariance matrix V_{k+1|k} of the body coordinate system is transformed into a prediction error covariance matrix P_{k+1|k} of the north-east-up coordinate system in accordance with Expression (54) described below. At this time, the drive noise error covariance matrix Qₖ is added to the prediction error covariance matrix P_{k+1|k} of the north-east-up coordinate system.

$${X}_{k + 1 \vert k} = {g}^{- 1} ( {Y}_{k + 1 \vert k} ) \qquad ( 53 )$$

$${P}_{k + 1 \vert k} = {Υ}_{k} {V}_{k + 1 \vert k} {Υ}_{k}^{T} + {Q}_{k} \qquad ( 54 )$$

$$Υ = [ \begin{matrix}{I}_{3 \times 3} & {0}_{3 \times 3} & {0}_{3 \times 3} \\ {0}_{3 \times 3} & B & {0}_{3 \times 3} \\ {0}_{3 \times 3} & {0}_{3 \times 3} & {I}_{3 \times 3}\end{matrix} ] \qquad ( 55 )$$

$$B = [ \begin{matrix}{b}_{11} & {b}_{12} & {b}_{13} \\ {b}_{21} & {b}_{22} & {b}_{23} \\ {b}_{31} & {b}_{32} & {b}_{33}\end{matrix} ] \qquad ( 56 )$$

$${b}_{11} = cos {γ}_{k} cos {η}_{k} \qquad ( 57 )$$

$${b}_{12} = - {V}_{k} sin {γ}_{k} cos {η}_{k} \qquad ( 58 )$$

$${b}_{13} = - {V}_{k} cos {γ}_{k} sin {η}_{k} \qquad ( 59 )$$

$${b}_{21} = cos {γ}_{k} sin {η}_{k} \qquad ( 60 )$$

$${b}_{22} = - {V}_{k} sin {γ}_{k} sin {η}_{k} \qquad ( 61 )$$

$${b}_{23} = {V}_{k} cos {γ}_{k} cos {η}_{k} \qquad ( 62 )$$

$${b}_{31} = sin {γ}_{k} \qquad ( 63 )$$

$${b}_{32} = {V}_{k} cos {γ}_{k} \qquad ( 64 )$$

$${b}_{33} = 0 \qquad ( 65 )$$

The tracking gate indicates a region where the target may be present at a sampling time tₖ. The gate size of the tracking gate is set to, for example, a beam width of a sensor (not illustrated). The beam width is obtained by a prediction angle calculated from the position vector of the north-east-up coordinate system. The prediction angle includes a prediction value of the elevation angle and a prediction value of the azimuth angle.

The smoothed value vector X_{k|k} for each motion model is calculated using the prediction value vector X_{k|k-1} of the north-east-up coordinate system indicated by Expression (53), the observation value vector Zₖ of the north-east-up coordinate system, the Kalman gain Kₖ for each motion model, and the observation matrix H for each motion model in the north-east-up coordinate system, as indicated by Expression (66) described below.

The smoothing error covariance matrix P_{k|k} for each motion model is calculated using the prediction error covariance matrix P_{k|k-1} of the north-east-up coordinate system indicated by Expression (54), the Kalman gain Kₖ for each motion model, and the observation matrix H for each motion model in the north-east-up coordinate system, as indicated by Expression (67) described below.

$${X}_{k \vert k} = {X}_{k \vert k - 1} + {K}_{k} [ \begin{matrix}{Z}_{k} - H & {X}_{k \vert k - 1}\end{matrix} ] \qquad ( 66 )$$

$${P}_{k \vert k} = [ \begin{matrix}{I}_{9 \times 9} - {K}_{k} & H\end{matrix} ] {P}_{k \vert k - 1} \qquad ( 67 )$$

$${K}_{k} = {{{P}_{k \vert k - 1} ( H )}^{T} [ \begin{matrix}H & {{P}_{k \vert k - 1} ( H )}^{T} + {R}_{k}\end{matrix} ]}^{- 1} \qquad ( 68 )$$

In Expression (68), Rₖ is an observation error covariance matrix represented by Expression (23).

Next, the operation of the target tracking device illustrated in FIG. 1 will be described.

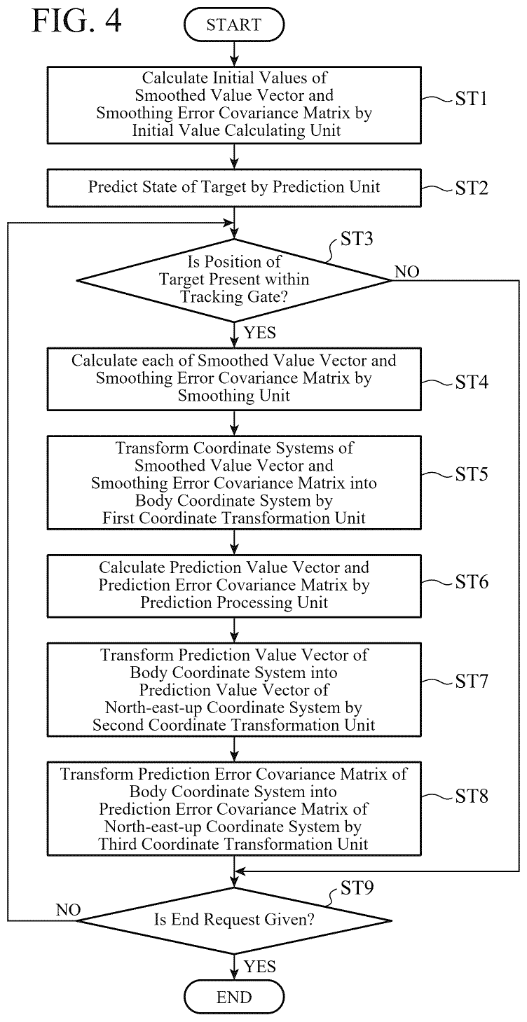

FIG. 4 is a flowchart illustrating a target tracking method which is a processing procedure performed by the target tracking device.

The tracking gate unit 1 acquires the observation value vector Zₖ which is position observation information indicating a target observation position from a sensor that observes the position of the target.

When the acquired position observation information is, for example, the position observation information at the first sampling time t₀ or the position observation information at the second sampling time t₁, the tracking gate unit 1 outputs the acquired position observation information to the initial value calculating unit 2.

The position observation information at the sampling time t₀ is the observation value vector Z₀, and the position observation information at the sampling time t₁ is the observation value vector Z₁.

The initial value calculating unit 2 acquires the observation value vector Z₀ at the first sampling time t₀ and the observation value vector Z₁ at the second sampling time t₁ from the tracking gate unit 1.

The initial value calculating unit 2 substitutes the observation value vector Z₀ and the observation value vector Z₁ into Expression (24) to calculate an initial value X_{0,1} of the smoothed value vector X_{k|k} of the north-east-up coordinate system.

In addition, the initial value calculating unit 2 calculates an initial value P_{0,1} of the smoothing error covariance matrix P_{k|k} by substituting the observation error covariance matrices R₀ and R₁ and the drive noise error covariance matrix Q₁ into Expression (25) (step ST1 in FIG. 4).

The initial value calculating unit 2 outputs each of the initial value X_{0,1} of the smoothed value vector X_{k|k} and the initial value P_{0,1} of the smoothing error covariance matrix P_{k|k} to the prediction unit 4.

Examples of the timing at which the initial value calculating unit 2 calculates the initial value X_{0,1} of the smoothed value vector X_{k|k}, etc. include a timing at which a new target is observed and a timing at which a target that is being tracked but disappears is observed again.

In the target tracking device illustrated in FIG. 1, the initial value calculating unit 2 calculates the initial value X_{0,1} of the smoothed value vector X_{k|k} on the basis of the observation value vector Z₀ at the first sampling time t₀ and the observation value vector Z₁ at the second sampling time t₁. However, this is merely an example, and the initial value calculating unit 2 may calculate the initial value of the smoothed value vector X_{k|k} on the basis of, for example, the observation value vector Z₁ at the second sampling time t₁ and the observation value vector Z₂ at the third sampling time t₂, or may calculate the initial value of the smoothed value vector X_{k|k} on the basis of the observation value vector Z₂ at the third sampling time t₂ and the observation value vector Z₃ at the fourth sampling time t₃.

The prediction unit 4 acquires each of the initial value X_{0,1} of the smoothed value vector X_{k|k} and the initial value P_{0,1} of the smoothing error covariance matrix P_{k|k} from the initial value calculating unit 2.

The prediction unit 4 predicts the state of the target using each of the initial value X_{0,1} of the smoothed value vector X_{k|k} and the initial value P_{0,1} of the smoothing error covariance matrix P_{k|k} (step ST2 in FIG. 4). The state of the target predicted by the prediction unit 4 is a future state of the target, and the prediction value indicating the future state of the target is a prediction value used by the smoothing unit 3 for the next estimation processing.

The prediction processing performed by the prediction unit 4 will be specifically described below.

The first coordinate transformation unit 4a acquires each of the initial value X_{0,1} of the smoothed value vector X_{k|k} and the initial value P_{0,1} of the smoothing error covariance matrix P_{k|k} from the initial value calculating unit 2.

The first coordinate transformation unit 4a transforms, in accordance with Expressions (4) to (6), the coordinate system of the smoothed value vector X_{k|k} indicating the initial value X_{0,1} into a body coordinate system as indicated by Expression (3). In Expression (3), the state vector Yₖ corresponds to a smoothed value vector Y_{k|k}.

That is, the first coordinate transformation unit 4a transforms the smoothed value vector X_{k|k} of the north-east-up coordinate system into the smoothed value vector Y_{k|k} of the body coordinate system. The state vector Yₖ of the body coordinate system is a vector based on the velocity vector including the magnitude of the velocity and the direction of the velocity.

In addition, the first coordinate transformation unit 4a transforms the coordinate system of the smoothing error covariance matrix P_{k|k} indicating the initial value P_{0,1} into a body coordinate system in accordance with Expression (30).

That is, the first coordinate transformation unit 4a transforms the smoothing error covariance matrix P_{k|k} of the north-east-up coordinate system into the smoothing error covariance matrix V_{k|k} of the body coordinate system.

The first coordinate transformation unit 4a outputs each of the smoothed value vector Y_{k|k} of the body coordinate system and the smoothing error covariance matrix V_{k|k} of the body coordinate system to the prediction processing unit 4b.

The prediction processing unit 4b acquires each of the smoothed value vector Y_{k|k} of the body coordinate system and the smoothing error covariance matrix V_{k|k} of the body coordinate system from the first coordinate transformation unit 4a.

The prediction processing unit 4b substitutes the smoothed value vector Y_{k|k} of the body coordinate system into Expression (42) to calculate a prediction value vector Y_{k+1|k} of the body coordinate system.

In addition, the prediction processing unit 4b substitutes the smoothing error covariance matrix V_{k|k} of the body coordinate system into Expression (43) to calculate a prediction error covariance matrix V_{k+1|k} of the body coordinate system.

The prediction processing unit 4b outputs each of the prediction value vector Y_{k+1|k} of the body coordinate system and the prediction error covariance matrix V_{k+1|k} of the body coordinate system to the second coordinate transformation unit 4c.

The second coordinate transformation unit 4c acquires each of the prediction value vector Y_{k+1|k} of the body coordinate system and the prediction error covariance matrix V_{k+1|k} of the body coordinate system from the prediction processing unit 4b.

The second coordinate transformation unit 4c transforms the prediction value vector Y_{k+1|k} of the body coordinate system into a prediction value vector X_{k+1|k} of the north-east-up coordinate system in accordance with Expression (53).

The second coordinate transformation unit 4c outputs each of the prediction value vector X_{k+1|k} of the north-east-up coordinate system and the prediction error covariance matrix V_{k+1|k} of the body coordinate system to the third coordinate transformation unit 4d.

The third coordinate transformation unit 4d acquires each of the prediction value vector X_{k+1|k} of the north-east-up coordinate system and the prediction error covariance matrix V_{k+1|k} of the body coordinate system from the second coordinate transformation unit 4c.

The third coordinate transformation unit 4d transforms the prediction error covariance matrix V_{k+1|k} of the body coordinate system into a prediction error covariance matrix P_{k+1|k} of the north-east-up coordinate system by substituting the prediction error covariance matrix V_{k+1|k} of the body coordinate system and the drive noise error covariance matrix Qₖ into Expression (53).

The third coordinate transformation unit 4d outputs each of the prediction value vector X_{k+1|k} of the north-east-up coordinate system and the prediction error covariance matrix P_{k+1|k} of the north-east-up coordinate system to the tracking gate unit 1.

The tracking gate unit 1 acquires the observation value vector Zₖ which is position observation information indicating a target observation position from a sensor that observes the position of the target. Here, the observation value vector Zₖ is position observation information at any one of the third and subsequent sampling times.

The tracking gate unit 1 acquires each of the prediction value vector X_{k+1|k} of the north-east-up coordinate system and the prediction error covariance matrix P_{k+1|k} of the north-east-up coordinate system from the third coordinate transformation unit 4d.

The tracking gate unit 1 determines whether or not the position of the target is present within the tracking gate on the basis of the position vectors xₖ, yₖ, and zₖ included in the observation value vector Zₖ.

If the position of the target is present within the tracking gate (YES in step ST3 in FIG. 4), the tracking gate unit 1 outputs each of the observation value vector Zₖ, the prediction value vector X_{k+1|k} of the north-east-up coordinate system, and the prediction error covariance matrix P_{k+1|k} of the north-east-up coordinate system to the smoothing unit 3.

If the position of the target is not present within the tracking gate (NO in step ST3 in FIG. 4), the tracking gate unit 1 does not output each of the observation value vector Zₖ, the prediction value vector X_{k+1|k} of the north-east-up coordinate system, and the prediction error covariance matrix P_{k+1|k} of the north-east-up coordinate system to the smoothing unit 3.

The smoothing unit 3 acquires each of the observation value vector Zₖ, the prediction value vector X_{k+1|k} of the north-east-up coordinate system, and the prediction error covariance matrix P_{k+1|k} of the north-east-up coordinate system from the tracking gate unit 1.

The smoothing unit 3 calculates a smoothed value vector X_{k|k} by substituting the observation value vector Zₖ and the prediction value vector X_{k+1|k} of the north-east-up coordinate system into Expression (66) (step ST4 in FIG. 4). The prediction value vector X_{k+1|k} is substituted into Expression (66) as a prediction value vector X_{k|k-1}.

In addition, the smoothing unit 3 calculates a smoothing error covariance matrix P_{k|k} by substituting the prediction error covariance matrix P_{k+1|k} of the north-east-up coordinate system into Expression (67) (step ST4 in FIG. 4). The prediction error covariance matrix P_{k+1|k} is substituted into Expression (67) as the prediction error covariance matrix P_{k|k-1}.

The smoothing unit 3 outputs each of the smoothed value vector X_{k|k} and the smoothing error covariance matrix P_{k|k} to the prediction unit 4.

In addition, the smoothing unit 3 outputs each of the smoothed value vector X_{k|k} and the smoothing error covariance matrix P_{k|k} to, for example, a display device (not illustrated) or a radar device (not illustrated).

The first coordinate transformation unit 4a acquires each of the smoothed value vector X_{k|k} and the smoothing error covariance matrix P_{k|k} from the smoothing unit 3.

The first coordinate transformation unit 4a transforms, in accordance with Expressions (4) to (6), the coordinate system of the smoothed value vector X_{k|k} into a body coordinate system as indicated by Expression (3) (step ST5 in FIG. 4).

That is, the first coordinate transformation unit 4a transforms the smoothed value vector X_{k|k} of the north-east-up coordinate system into the smoothed value vector Y_{k|k} of the body coordinate system.

In addition, the first coordinate transformation unit 4a transforms the coordinate system of the smoothing error covariance matrix P_{k|k} into a body coordinate system according to Expression (30) (step ST5 in FIG. 4).

That is, the first coordinate transformation unit 4a transforms the smoothing error covariance matrix P_{k|k} of the north-east-up coordinate system into the smoothing error covariance matrix V_{k|k} of the body coordinate system.

The first coordinate transformation unit 4a outputs each of the state vector Yₖ of the body coordinate system and the smoothing error covariance matrix V_{k|k} of the body coordinate system to the prediction processing unit 4b.

The prediction processing unit 4b acquires each of the smoothed value vector Y_{k|k} of the body coordinate system and the smoothing error covariance matrix V_{k|k} of the body coordinate system from the first coordinate transformation unit 4a.

The prediction processing unit 4b substitutes the smoothed value vector Y_{k|k} of the body coordinate system into Expression (42) to calculate a prediction value vector Y_{k+1|k} of the body coordinate system (step ST6 in FIG. 4).

In addition, the prediction processing unit 4b substitutes the smoothing error covariance matrix V_{k|k} of the body coordinate system into Expression (43) to calculate a prediction error covariance matrix V_{k+1|k} of the body coordinate system (step ST6 in FIG. 4).

The prediction processing unit 4b outputs each of the prediction value vector Y_{k+1|k} of the body coordinate system and the prediction error covariance matrix V_{k+1|k} of the body coordinate system to the second coordinate transformation unit 4c.

The second coordinate transformation unit 4c acquires each of the prediction value vector Y_{k+1|k} of the body coordinate system and the prediction error covariance matrix V_{k+1|k} of the body coordinate system from the prediction processing unit 4b.

The second coordinate transformation unit 4c transforms the prediction value vector Y_{k+1|k} of the body coordinate system into a prediction value vector X_{k+1|k} of the north-east-up coordinate system in accordance with Expression (53) (step ST7 in FIG. 4).

The second coordinate transformation unit 4c outputs each of the prediction value vector X_{k+1|k} of the north-east-up coordinate system and the prediction error covariance matrix V_{k+1|k} of the body coordinate system to the third coordinate transformation unit 4d.

The third coordinate transformation unit 4d acquires each of the prediction value vector X_{k+1|k} of the north-east-up coordinate system and the prediction error covariance matrix V_{k+1|k} of the body coordinate system from the second coordinate transformation unit 4c.

The third coordinate transformation unit 4d transforms the prediction error covariance matrix V_{k+1|k} of the body coordinate system into the prediction error covariance matrix P_{k+1|k} of the north-east-up coordinate system by substituting the prediction error covariance matrix V_{k+1|k} of the body coordinate system and the drive noise error covariance matrix Qₖ into Expression (53) (step ST8 in FIG. 4).

The third coordinate transformation unit 4d outputs each of the prediction value vector X_{k+1|k} of the north-east-up coordinate system and the prediction error covariance matrix P_{k+1|k} of the north-east-up coordinate system to the tracking gate unit 1.

When an end request of the target tracking processing is not given to the target tracking device (NO in step ST9 in FIG. 4), the processes of steps ST3 to ST8 are repeated.

When the end request of the target tracking processing is given to the target tracking device (YES in step ST9 in FIG. 4), a series of the processing performed by the target tracking device ends.

In the first embodiment described above, the target tracking device includes an initial value calculating unit 2 that acquires position observation information indicating target observation positions at two different sampling times from a sensor that observes the position of a target, and calculates an initial value of a smoothed value including a position vector of the target and a velocity vector of the target as an initial value of the smoothed value indicating the state of the target on the basis of the position observation information. In addition, the target tracking device includes a smoothing unit 3 that performs estimation processing of estimating a smoothed value indicating the state of the target using the position observation information output from the sensor and a prediction value indicating the state of the target, and a prediction unit 4 that predicts a future state of the target by using the initial value of the smoothed value calculated by the initial value calculating unit 2 or the smoothed value estimated by the smoothing unit 3 and outputs a prediction value indicating a result of predicting the future state of the target to the smoothing unit 3 as a prediction value to be used by the smoothing unit 3 for next estimation processing. Therefore, the target tracking device can suppress deterioration of prediction accuracy due to a large deviation of an initial value of the smoothed value from an original smoothed value.

### Second Embodiment

The second embodiment will describe a target tracking device including a prediction unit 6 that performs prediction processing based on each of a plurality of motion hypotheses. The motion hypothesis corresponds to a motion model.

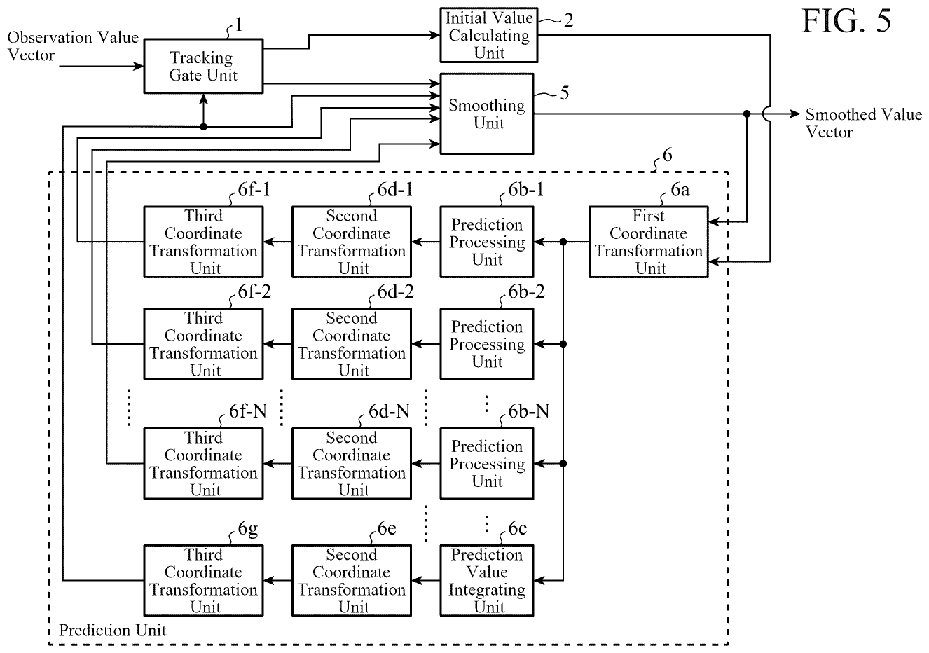

FIG. 5 is a configuration diagram illustrating a target tracking device according to the second embodiment. In FIG. 5, elements same as or corresponding to the elements in FIG. 1 are identified by the same reference numerals, and thus, the description thereof will be omitted.

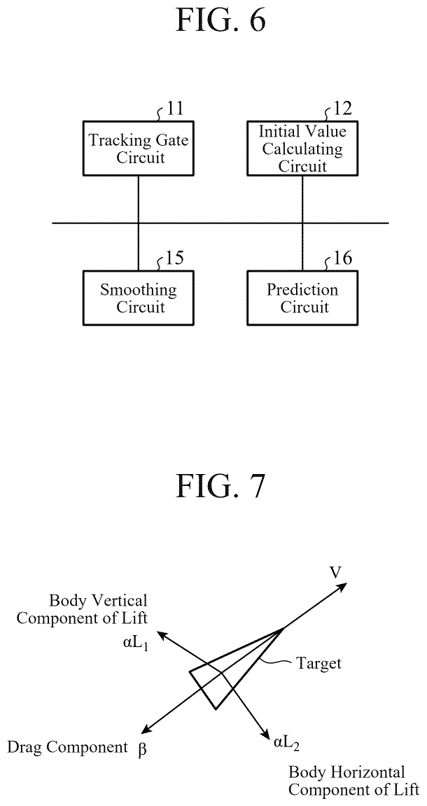

FIG. 6 is a hardware configuration diagram illustrating hardware of the target tracking device according to the second embodiment. In FIG. 6, elements same as or corresponding to the elements in FIG. 2 are identified by the same reference numerals, and thus, the description thereof will be omitted.

The target tracking device illustrated in FIG. 5 includes a tracking gate unit 1, an initial value calculating unit 2, a smoothing unit 5, and the prediction unit 6.

The smoothing unit 5 is implemented by a smoothing circuit 15 illustrated in FIG. 6.

The smoothing unit 5 acquires position observation information from the tracking gate unit 1 and acquires a plurality of prediction values and a plurality of prediction error covariance matrices from the prediction unit 6.

The smoothing unit 5 performs estimation processing of estimating a smoothed value indicating the state of the target using the position observation information, each of the prediction values, and each of the prediction error covariance matrices.

The smoothing unit 5 also calculates a smoothing error covariance matrix on the basis of each of the prediction error covariance matrices.

The smoothing unit 5 outputs each of a plurality of smoothed values and each of a plurality of smoothing error covariance matrices to the prediction unit 6.

The prediction unit 6 is implemented by a prediction circuit 16 illustrated in FIG. 6.

The prediction unit 6 includes a first coordinate transformation unit 6a, prediction processing units 6b-1 to 6b-N, a prediction value integrating unit 6c, second coordinate transformation units 6d-1 to 6d-N and 6e, and third coordinate transformation units 6f-1 to 6f-N and 6g.

The prediction unit 6 acquires the initial value of a smoothed value from the initial value calculating unit 2 or the smoothed value from the smoothing unit 5.

The prediction unit 6 performs prediction processing based on each of a plurality of motion hypotheses of the target using the initial value of the smoothed value or the smoothed value, and calculates a plurality of prediction values.

The prediction unit 6 outputs the plurality of prediction values to the smoothing unit 5 as prediction values used by the smoothing unit 5 for the next estimation processing. The prediction unit 6 outputs some prediction values to the tracking gate unit 1.

Further, the prediction unit 6 acquires the initial value of the smoothing error covariance matrix from the initial value calculating unit 2 or a plurality of smoothing error covariance matrices from the smoothing unit 5.

The prediction unit 6 calculates a prediction error covariance matrix using the initial value of the smoothing error covariance matrix or each of the smoothing error covariance matrices.

The prediction unit 6 outputs the plurality of prediction error covariance matrices to the smoothing unit 5.

The first coordinate transformation unit 6a acquires the initial value of the smoothed value from the initial value calculating unit 2 or a plurality of smoothed values from the smoothing unit 5.

The first coordinate transformation unit 6a transforms the coordinate system of the initial value of the smoothed value or the coordinate system of each of the smoothed values from a north-east-up coordinate system to a body coordinate system of the target.

The first coordinate transformation unit 6a outputs the initial value of the smoothed value of the body coordinate system to each of the prediction processing units 6b-1 to 6b-N and the prediction value integrating unit 6c.

In addition, the first coordinate transformation unit 6a outputs any one of the plurality of smoothed values of the body coordinate system to the prediction processing unit 6b-n (n=1, 2, . . . , N), and outputs the plurality of smoothed values of the body coordinate system to the prediction value integrating unit 6c.

Further, the first coordinate transformation unit 6a acquires the initial value of the smoothing error covariance matrix from the initial value calculating unit 2 or the plurality of smoothing error covariance matrices from the smoothing unit 5.

The first coordinate transformation unit 6a transforms the coordinate system of the initial value of the smoothing error covariance matrix or the coordinate system of each of the smoothing error covariance matrices from the north-east-up coordinate system to the body coordinate system.

The first coordinate transformation unit 6a outputs the initial value of the smoothing error covariance matrix of the body coordinate system to each of the prediction processing units 6b-1 to 6b-N and the prediction value integrating unit 6c.

The first coordinate transformation unit 6a outputs any one of the plurality of smoothing error covariance matrices of the body coordinate system to the prediction processing unit 6b-n, and outputs the plurality of smoothing error covariance matrices of the body coordinate system to the prediction value integrating unit 6c.

The prediction processing unit 6b-n (n=1, 2, . . . , N) acquires the initial value of the smoothed value of the body coordinate system or any one of the plurality of smoothed values of the body coordinate system from the first coordinate transformation unit 6a. N is an integer greater than or equal to 2.

The prediction processing unit 6b-n performs prediction processing based on the n-th motion hypothesis using the initial value of the smoothed value of the body coordinate system or the smoothed value of the body coordinate system to calculate a prediction value.

The prediction processing unit 6b-n outputs the prediction value of the body coordinate system to the second coordinate transformation unit 6d-n.

In addition, the prediction processing unit 6b-n acquires the initial value of the smoothing error covariance matrix of the body coordinate system or any one of the plurality of smoothing error covariance matrices of the body coordinate system from the first coordinate transformation unit 6a.

The prediction processing unit 6b-n calculates a prediction error covariance matrix using the initial value of the smoothing error covariance matrix of the body coordinate system or the smoothing error covariance matrix of the body coordinate system.

The prediction processing unit 6b-n outputs the prediction error covariance matrix of the body coordinate system to the second coordinate transformation unit 6d-n.

The prediction value integrating unit 6c acquires the initial value of the smoothed value of the body coordinate system or the plurality of smoothed values of the body coordinate system from the first coordinate transformation unit 6a.

The prediction value integrating unit 6c performs prediction processing based on the first to N-th motion hypotheses as N motion hypotheses using the initial value of the smoothed value of the body coordinate system or the smoothed values of the body coordinate system to calculate a prediction value.

Further, the prediction value integrating unit 6c acquires a plurality of smoothing error covariance matrices of the body coordinate system from the first coordinate transformation unit 6a.

The prediction value integrating unit 6c calculates a prediction error covariance matrix using a plurality of smoothing error covariance matrices of the body coordinate system.

The prediction value integrating unit 6c outputs each of the prediction value of the body coordinate system and the prediction error covariance matrix of the body coordinate system to the second coordinate transformation unit 6e.

The second coordinate transformation unit 6d-n (n=1, 2, . . . , N) acquires each of the prediction value of the body coordinate system and the prediction error covariance matrix of the body coordinate system from the prediction processing unit 6b-n.

The second coordinate transformation unit 6d-n transforms the prediction value of the body coordinate system to a prediction value of the north-east-up coordinate system.

The second coordinate transformation unit 6d-n outputs each of the prediction value of the north-east-up coordinate system and the prediction error covariance matrix of the body coordinate system to the third coordinate transformation unit 6f-n.

The second coordinate transformation unit 6e acquires each of the prediction value of the body coordinate system and the prediction error covariance matrix of the body coordinate system from the prediction value integrating unit 6c.

The second coordinate transformation unit 6e transforms the prediction value of the body coordinate system to a prediction value of the north-east-up coordinate system.

The second coordinate transformation unit 6e outputs each of the prediction value of the north-east-up coordinate system and the prediction error covariance matrix of the body coordinate system to the third coordinate transformation unit 6g.

The third coordinate transformation unit 6f-n (n=1, 2, . . . , N) acquires each of the prediction value of the north-east-up coordinate system and the prediction error covariance matrix of the body coordinate system from the second coordinate transformation unit 6d-n.

The third coordinate transformation unit 6f-n transforms the prediction error covariance matrix of the body coordinate system to a prediction error covariance matrix of the north-east-up coordinate system, and adds drive noise to the transformed prediction error covariance matrix.

The third coordinate transformation unit 6f-n outputs the prediction value with drive noise to the smoothing unit 5.

The third coordinate transformation unit 6g acquires each of the prediction value of the north-east-up coordinate system and the prediction error covariance matrix of the body coordinate system from the second coordinate transformation unit 6e.

The third coordinate transformation unit 6g transforms the prediction value of the north-east-up coordinate system to a prediction error covariance matrix of the north-east-up coordinate system, and adds drive noise to the transformed prediction error covariance matrix.

The third coordinate transformation unit 6g outputs the prediction value of the north-east-up coordinate system to the tracking gate unit 1.

Further, the third coordinate transformation unit 6g outputs each of the prediction value of the north-east-up coordinate system and the prediction error covariance matrix with drive noise to the smoothing unit 5.

In FIG. 5, it is assumed that each of the tracking gate unit 1, the initial value calculating unit 2, the smoothing unit 5, and the prediction unit 6, which are components of the target tracking device, is implemented by dedicated hardware as illustrated in FIG. 6. That is, it is assumed that the target tracking device is implemented by the tracking gate circuit 11, the initial value calculating circuit 12, the smoothing circuit 15, and the prediction circuit 16.

Each of the tracking gate circuit 11, the initial value calculating circuit 12, the smoothing circuit 15, and the prediction circuit 16 is, for example, a single circuit, a composite circuit, a programmed processor, a parallel programmed processor, an ASIC, an FPGA, or a combination of some of these circuits.

The components of the target tracking device are not limited to be implemented by dedicated hardware, and the target tracking device may be implemented by software, firmware, or a combination of software and firmware.

In a case where the target tracking device is implemented by software, firmware, or the like, a program for causing a computer to execute the processing procedures of the tracking gate unit 1, the initial value calculating unit 2, the smoothing unit 5, and the prediction unit 6 is stored in the memory 21 illustrated in FIG. 3. Then, the processor 22 illustrated in FIG. 3 executes the program stored in the memory 21.

Further, FIG. 6 shows an example in which each of the components of the target tracking device is implemented by dedicated hardware, and FIG. 3 shows an example in which the target tracking device is implemented by software, firmware, or the like. However, this is merely an example, and some components of the target tracking device may be implemented by dedicated hardware, and the remaining components may be implemented by software, firmware, or the like.

The motion model of the target tracking device illustrated in FIG. 5 is obtained by adding a constant aerodynamic vector to the motion model of the target tracking device illustrated in FIG. 1 as expressed by Expression (69) described below.

$${Y}_{k + 1} = {Y}_{k} + f ( {Y}_{k} + {Γ}_{k - 1} {u}_{k - 1} ) Δ t \qquad ( 69 )$$

$${u}_{k} = {α}_{1} , {u}_{k} = {α}_{2} , … , OR , {u}_{k} = {α}_{n} \qquad ( 70 )$$

uₖ is a constant aerodynamic vector constituting each of the N motion models at the sampling time tₖ.

FIG. 7 is an explanatory diagram illustrating a constant aerodynamic vector αₙ.

The constant aerodynamic vector αₙ includes a fuselage vertical component α_{L1} of lift, a fuselage horizontal component α_{L2} of lift, and a drag component β in a direction opposite to the velocity vector V as expressed by Expression (71) described below.

$${α}_{n} = [ \begin{matrix}{Δα}_{{L}_{1}} \\ {Δα}_{{L}_{1}} \\ Δβ\end{matrix} ] \qquad ( 71 )$$

In Expression (69), Γₖ is a transformation matrix of a constant aerodynamic vector at the sampling time tₖ, and is expressed as Expression (72) described below.

$${Γ}_{k - 1} = ( \begin{matrix}{0}_{3 \times 3} \\ {0}_{3 \times 3} \\ {I}_{3 \times 3}\end{matrix} ) \qquad ( 72 )$$

α_{L1}, α_{L2}, and β included in the state vector Yₖ are added to the constant aerodynamic vector αₙ assumed as in Expression (70).

When a combination example of constant aerodynamic vectors at the sampling time tₖ is described as Expression (73) described below, a motion hypothesis in a case where the description is true is expressed as Expression (74) described below.

$${u}_{k - 1} = {α}_{a} ( a = 1 , 2 , … , N ) \qquad ( 73 )$$

$${Ψ}_{k , a} ( a = 1 , 2 , … , N ) \qquad ( 74 )$$

The transition probability p_{k,ab} between motion models at the sampling time tₖ is expressed by Expression (75) described below. The transition probability p_{k,ab} between motion models is a transition probability between motion models in a case where the sampling interval between the sampling time tₖ and the sampling time tₖ₋₁ is tₛ=tₖ−tₖ₋₁.

$${p}_{k , a b} = P [ {Ψ}_{k , a} \vert {Ψ}_{k - 1 , b} ] ( a = 1 , 2 , … N ; b = 1 , 2 , … , N ) \qquad ( 75 )$$

The reliability of the motion hypothesis at the sampling time tₖ based on the observation value vector Zₖ up to the sampling time tₖ is calculated as Expression (77) described below, if Expression (76) described below is defined by a conditional probability density function.

$${μ}_{k , a} ( + ) = P [ {Ψ}_{k , a} \vert {Z}_{k} ] \qquad ( 76 )$$

$${μ}_{k , a} ( + ) = \frac{{\sum }_{b = 1}^{N} {v}_{k , a} {p}_{k , ab} {μ}_{k - 1 , b} ( + )}{{\sum }_{a = 1}^{N} {\sum }_{b = 1}^{N} {v}_{k , a} {p}_{k , a b} {μ}_{k - 1 , b} ( + )} \qquad ( 77 )$$

In Expression (77), v_{k,a} is a normal distribution approximation P[Z|Ψ_{k,a}, Zₖ₋₁] of the observation vector approximated by a multivariate normal distribution, and is calculated as Expression (78) described below on the basis of the prediction value of the north-east-up coordinate system.

$${v}_{k , a} = h ( {z}_{k} ; {HX}_{k \vert k - 1 , a} , {HP}_{k \vert k - 1 , a} {H}^{T} + {R}_{k} ) \qquad ( 78 )$$

The prior reliability of the motion hypothesis at the sampling time tₖ based on the observation value vector Zₖ₋₁ up to the sampling time tₖ₋₁ is calculated as Expression (80) described below, if Expression (79) described below is defined by a conditional probability density function.

$${μ}_{k , a} ( - ) = P [ {Ψ}_{k , a} \vert {Z}_{k - 1} ] \qquad ( 79 )$$

$${μ}_{k , a} ( - ) = {\sum }_{a = 1}^{N} {p}_{k , ab} {μ}_{k - 1 , b} ( - ) \qquad ( 80 )$$

If the estimated value uₖ₋₁ (+) of the constant acceleration vector based on the observation value vector Zₖ up to the sampling time tₖ is defined as Expression (81) described below, the estimated value uₖ₋₁(+) of the constant acceleration vector is expressed as Expression (82) described below. The estimated value uₖ₋₁(+) of the constant acceleration vector is hereinafter referred to as an estimated aerodynamic vector.

$${u}_{k - 1} ( + ) = E [ {u}_{k - 1} \vert {Z}_{k} ] \qquad ( 81 )$$

$${u}_{k - 1} ( + ) = {\sum }_{a = 1}^{N} {μ}_{k , a} ( + ) {α}_{a} \qquad ( 82 )$$

If the estimated value uₖ₋₁(−) of the constant acceleration vector based on the observation value vector Zₖ₋₁ up to the sampling time tₖ₋₁ is defined as Expression (83), the estimated value uₖ₋₁(−) of the constant acceleration vector is expressed as Expression (84) described below. The estimated value uₖ₋₁(−) of the constant acceleration vector is hereinafter referred to as a predicted aerodynamic vector.

$${u}_{k - 1} ( - ) = E [ {u}_{k - 1} \vert {Z}^{k - 1} ] \qquad ( 83 )$$

$${u}_{k - 1} ( - ) = {\sum }_{a = 1}^{N} {μ}_{k , a} ( - ) {α}_{a} \qquad ( 84 )$$

Based on the theory of the Kalman filter, the estimated value X_{k|k} of the state vector Xₖ in a case where the observation value vector Zₖ is obtained at the sampling time tₖ in accordance with the motion model and the observation model is calculated as follows.

The processing of calculating the initial value of the smoothed value vector and the processing of transforming the coordinate system into the body coordinate system are similar to those in the first embodiment.

(1a) Prediction Processing Based on n-th (n=1, 2, . . . , N) Motion Hypothesis In the prediction processing based on the n-th motion hypothesis, the prediction value vector Y_{k|k-1,a} is calculated as in Expression (85) described below, and the prediction error covariance matrix V_{k|k-1,a} is calculated as in Expression (86) described below.

$${Y}_{k \vert k - 1 , a} = {Y}_{k - 1 \vert k - 1} + f ( {Y}_{k - 1 \vert k - 1} + {Γ}_{k - 1} {\underline{α}}_{a} ) Δ t ( a = 1 , 2 , … , N ) \qquad ( 85 )$$

$${V}_{k \vert k - 1 , a} = {Φ}_{k - 1} {V}_{k - 1 \vert k - 1} {Φ}_{k - 1}^{T} ( a = 1 , 2 , … , N ) \qquad ( 86 )$$

The coordinate system of the prediction value vector Y_{k|k-1,a} is transformed from the body coordinate system to the north-east-up coordinate system.

That is, the prediction value vector Y_{k|k-1,a} of the body coordinate system is transformed into a prediction value vector X_{k|k-1,a} of the north-east-up coordinate system. Expression (87) described below represents coordinate transformation of the prediction value vector Y_{k|k-1,a}.

The coordinate system of the prediction error covariance matrix V_{k|k-1,a} is transformed from the body coordinate system to the north-east-up coordinate system.

That is, the prediction error covariance matrix V_{k|k-1,a} of the body coordinate system is transformed into a prediction error covariance matrix P_{k|k-1,a} of the north-east-up coordinate system. Expression (88) described below represents coordinate transformation of the prediction error covariance matrix V_{k+1|k,a}. A drive noise error covariance matrix Qₖ is added to the prediction error covariance matrix P_{k+1|k,a}.

$${X}_{k + 1 \vert k , a} = {g}^{- 1} ( {Y}_{k + 1 \vert k , a} ) \qquad ( 87 )$$

$${P}_{k + 1 \vert k , a} = {ϒ}_{k} {V}_{k + 1 \vert k , a} {ϒ}_{k}^{T} + {Q}_{k} \qquad ( 88 )$$

In Expression (88), Yₖ is the Jacobian matrix represented by Expression (55).

### (2a) Prediction Processing Based on N Motion Hypothesis

In the prediction processing based on the first to N-th motion hypothesis as N motion hypotheses, the prediction value vector Y_{k|k-1} is calculated as in Expression (89) described below, and the prediction error covariance matrix V_{k|k-1} is calculated as in Expression (90) described below.

The predicted aerodynamic vector uₖ₋₁(−) is calculated in accordance with Expression (84).

$${Y}_{k \vert k - 1} = {Y}_{k - 1 \vert k - 1} + f ( {X}_{k - 1 \vert k - 1} + {Γ}_{k - 1} {u}_{k - 1} ( - ) ) Δ t \qquad ( 89 )$$

$${V}_{k \vert k - 1} = {V}_{k \vert k - 1 , a} + {\sum }_{a = 1}^{N} {μ}_{k - 1 , a} ( - ) {Γ}_{k - 1} ( {\underline{α}}_{a} - {u}_{k - 1} ( - ) ) {( {\underline{α}}_{a} - {u}_{k - 1} ( - ) )}^{T} {Γ}_{k - 1}^{T} \qquad ( 90 )$$

The coordinate system of the prediction value vector Y_{k|k-1} is transformed from the body coordinate system to the north-east-up coordinate system.

That is, the prediction value vector Y_{k|k-1} of the body coordinate system is transformed into a prediction value vector X_{k|k-1,a} of the north-east-up coordinate system. Expression (91) described below represents coordinate transformation of the prediction value vector Y_{k+1|k}.

The coordinate system of the prediction error covariance matrix V_{k|k-1} is transformed from the body coordinate system to the north-east-up coordinate system.

That is, the prediction error covariance matrix V_{k|k-1} of the body coordinate system is transformed into a prediction error covariance matrix P_{k|k-1} of the north-east-up coordinate system. Expression (92) represents coordinate transformation of the prediction error covariance matrix V_{k+1|k}. A drive noise error covariance matrix Qₖ is added to the prediction error covariance matrix P_{k+1|k}.

$${X}_{k + 1 \vert k} = {g}^{- 1} ( {Y}_{k + 1 \vert k} ) \qquad ( 91 )$$

$${P}_{k + 1 \vert k} = {ϒ}_{k} {V}_{k + 1 \vert k} {ϒ}_{k}^{T} + {Q}_{k} \qquad ( 92 )$$

(1b) Smoothing Processing Based on n-th (n=1, 2, . . . , N) Motion Hypothesis

In the smoothing processing based on the n-th motion hypothesis, the smoothed value vector X_{k|k,a} is calculated as in Expression (93) described below, and the smoothing error covariance matrix P_{k|k,a} is calculated as in Expression (94) described below.

$${X}_{k \vert k , a} = {X}_{k \vert k - 1 , a} + {K}_{k} ( {Z}_{k} - H {X}_{k \vert k - 1 , a} ) ( a = 1 , 2 , … , N ) \qquad ( 93 )$$

$${P}_{k \vert k , a} = ( I - {K}_{k} H ) {P}_{k \vert k - 1 , a} ( a = 1 , 2 , … , N ) \qquad ( 94 )$$

$${K}_{k} = {P}_{k \vert k - 1 , a} {{H}^{T} ( {HP}_{k \vert k - 1 , a} {H}^{T} + {R}_{k} )}^{- 1} \qquad ( 95 )$$

### (2b) Smoothing Processing Based on N Motion Hypothesis

In the smoothing processing based on N motion hypothesis, the smoothed value vector X_{k|k} is calculated as in Expression (96) described below, and the smoothing error covariance matrix P_{k|k,a} is calculated as in Expression (97) described below.

$${X}_{k \vert k} = {g}^{- 1} ( {Y}_{k - 1 \vert k - 1} + f ( {Y}_{k - 1 \vert k - 1} + {Γ}_{k - 1} {u}_{k - 1} ( + ) ) Δ t ) + {K}_{k} [ {Z}_{k} - H ( {g}^{- 1} ( {Y}_{k \vert k - 1} ( - ) + f ( {Y}_{k - 1 \vert k - 1} + {Γ}_{k - 1} {u}_{k - 1} ( + ) ) Δ t ) ) ] \qquad ( 96 )$$

$${P}_{k \vert k} = {P}_{k \vert k , a} + {\sum }_{a = 1}^{N} {μ}_{k , a} ( + ) ( I - {K}_{k} H ) {Γ}_{k - 1} ( {α}_{a} - {u}_{k - 1} ( + ) ) {( {α}_{a} - {u}_{k - 1} ( + ) )}^{T} {{Γ}_{k - 1}^{T} ( I - {K}_{k} H )}^{T} \qquad ( 97 )$$

Next, the operation of the target tracking device illustrated in FIG. 5 will be described.

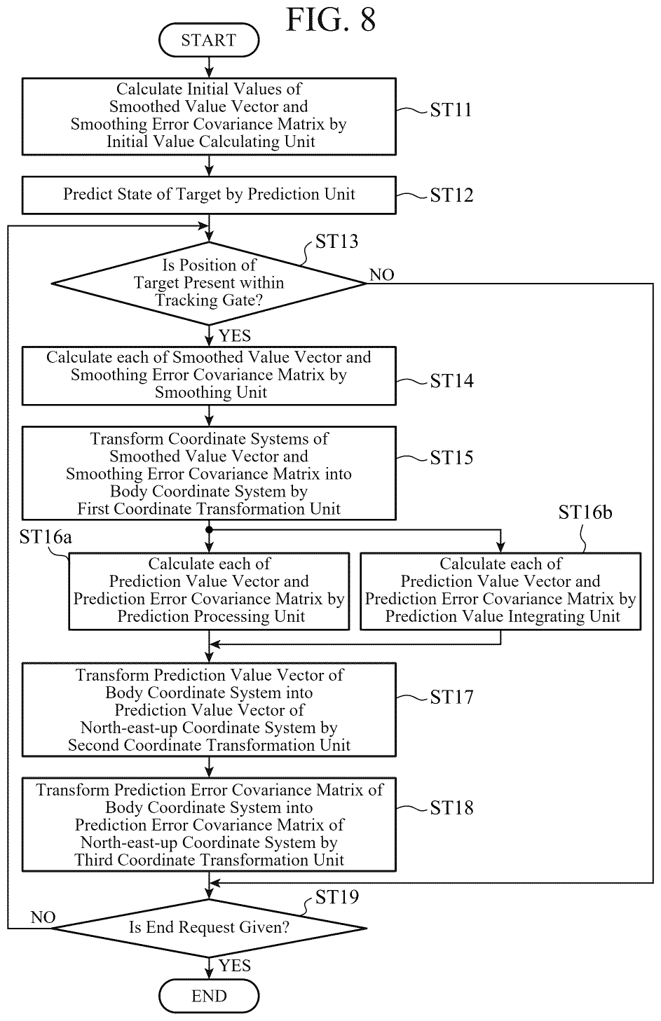

FIG. 8 is a flowchart illustrating a target tracking method which is a processing procedure performed by the target tracking device.

The tracking gate unit 1 acquires the observation value vector Zₖ which is position observation information indicating a target observation position from a sensor that observes the position of the target.

When the acquired position observation information is the position observation information at the first sampling time t₀ from the top or the position observation information at the second sampling time t₁ from the top, the tracking gate unit 1 outputs the acquired position observation information to the initial value calculating unit 2.

The position observation information at the sampling time t₀ is the observation value vector Z₀, and the position observation information at the sampling time t₁ is the observation value vector Z₁.

The initial value calculating unit 2 acquires the observation value vector Z₀ at the first sampling time t₀ and the observation value vector Z₁ at the second sampling time t₁ from the tracking gate unit 1.

The initial value calculating unit 2 substitutes the observation value vector Z₀ and the observation value vector Z₁ into Expression (24) to calculate an initial value X_{0,1} of the smoothed value vector X_{k|k} of the north-east-up coordinate system.

In addition, the initial value calculating unit 2 substitutes the observation error covariance matrices R₀ and R₁ and the drive noise error covariance matrix Q₁ into Expression (25) to calculate an initial value P_{0,1} of the smoothing error covariance matrix (step ST11 in FIG. 8).

The initial value calculating unit 2 outputs each of the initial value X_{0,1} of the smoothed value vector X_{k|k} and the initial value P_{0,1} of the smoothing error covariance matrix P_{k|k} to the prediction unit 6.

The prediction unit 6 acquires each of the initial value X_{0,1} of the smoothed value vector X_{k|k} and the initial value P_{0,1} of the smoothing error covariance matrix P_{k|k} from the initial value calculating unit 2.

The prediction unit 6 predicts the state of the target using each of the initial value X_{0,1} of the smoothed value vector X_{k|k} and the initial value P_{0,1} of the smoothing error covariance matrix P_{k|k} (step ST12 in FIG. 8). The state of the target predicted by the prediction unit 6 is a future state of the target, and the prediction value indicating the future state of the target is a prediction value used by the smoothing unit 5 for the next estimation processing.

The prediction processing performed by the prediction unit 6 will be specifically described below.

The first coordinate transformation unit 6a acquires each of the initial value X_{0,1} of the smoothed value vector X_{k|k} and the initial value P_{0,1} of the smoothing error covariance matrix P_{k|k} from the initial value calculating unit 2.

The first coordinate transformation unit 6a transforms, in accordance with Expressions (4) to (6), the coordinate system of the smoothed value vector X_{k|k} indicating the initial value X_{0,1} into a body coordinate system as indicated by Expression (3).

That is, the first coordinate transformation unit 6a transforms the smoothed value vector X_{k|k} of the north-east-up coordinate system into a smoothed value vector Y_{k|k} of the body coordinate system. The state vector Yₖ of the body coordinate system is a vector based on the velocity vector including the magnitude of the velocity and the direction of the velocity.

In addition, the first coordinate transformation unit 6a transforms the coordinate system of the smoothing error covariance matrix P_{k|k} indicating the initial value P_{0,1} into a body coordinate system in accordance with Expression (30).

That is, the first coordinate transformation unit 6a transforms the smoothing error covariance matrix P_{k|k} of the north-east-up coordinate system into a smoothing error covariance matrix V_{k|k} of the body coordinate system.

The first coordinate transformation unit 6a outputs the smoothed value vector Y_{k|k} of the body coordinate system and the smoothing error covariance matrix V_{k|k} of the body coordinate system to each of the prediction processing units 6b-1 to 6b-N and the prediction value integrating unit 6c.

The prediction processing unit 6b-n (n=1, . . . , N) acquires each of the smoothed value vector Y_{k|k} of the body coordinate system and the smoothing error covariance matrix V_{k|k} of the body coordinate system from the first coordinate transformation unit 6a.

The prediction processing unit 6b-n substitutes the smoothed value vector Y_{k|k} of the body coordinate system into Expression (85) to calculate a prediction value vector Y_{k+1|k,a} of the body coordinate system. In Expression (85), Y_{k-1|k-1} corresponds to Y_{k|k}, and Y_{k|k-1,a} corresponds to Y_{k+1|k,a}.

In addition, the prediction processing unit 6b-n substitutes the smoothing error covariance matrix V_{k|k} of the body coordinate system into Expression (86) to calculate a prediction error covariance matrix V_{k+1|k,a} of the body coordinate system. In Expression (86), V_{k-1|k-1} corresponds to V_{k|k}, and V_{k|k-1,a} corresponds to V_{k+1|k,a}.

The prediction processing unit 6b-n outputs each of the prediction value vector Y_{k+1|k} of the body coordinate system and the prediction error covariance matrix V_{k+1|k} of the body coordinate system to the second coordinate transformation unit 6d-n.

The prediction value integrating unit 6c acquires each of the smoothed value vector Y_{k|k} of the body coordinate system and the smoothing error covariance matrix V_{k|k} of the body coordinate system from the first coordinate transformation unit 6a.

The prediction value integrating unit 6c calculates a prediction value vector Y_{k+1|k} of the body coordinate system by substituting the smoothed value vector Y_{k|k} of the body coordinate system into Expression (89). In Expression (89), Y_{k-1|k-1} corresponds to Y_{k|k}, and Y_{k|k-1} corresponds to Y_{k+1|k}.

In addition, the prediction value integrating unit 6c substitutes the smoothing error covariance matrix V_{k|k} of the body coordinate system into Expression (90) to calculate a prediction error covariance matrix V_{k+1|k} of the body coordinate system. In Expression (90), V_{k|k-1,a} corresponds to V_{k|k} , and V_{k|k-1} corresponds to V_{k+1|k}.

The prediction value integrating unit 6c outputs each of the prediction value vector Y_{k+1|k} of the body coordinate system and the prediction error covariance matrix V_{k+1|k} of the body coordinate system to the second coordinate transformation unit 6e.

The second coordinate transformation unit 6d-n (n=1, . . . , N) acquires each of the prediction value vector Y_{k+1|k,a} of the body coordinate system and the prediction error covariance matrix V_{k+1|k,a} of the body coordinate system from the prediction processing unit 6b-n.

The second coordinate transformation unit 6d-n transforms the prediction value vector Y_{k+1|k,a} of the body coordinate system into a prediction value vector X_{k+1|k,a} of the north-east-up coordinate system in accordance with Expression (87).

The second coordinate transformation unit 6d-n outputs each of the prediction value vector X_{k+1|k,a} of the north-east-up coordinate system and the prediction error covariance matrix V_{k+1|k,a} of the body coordinate system to the third coordinate transformation unit 6f-n.

The third coordinate transformation unit 6f-n acquires each of the prediction value vector X_{k+1|k,a} of the north-east-up coordinate system and the prediction error covariance matrix V_{k+1|k,a} of the body coordinate system from the second coordinate transformation unit 6d-n.

The third coordinate transformation unit 6f-n transforms the prediction error covariance matrix V_{k+1|k,a} of the body coordinate system into a prediction error covariance matrix P_{k+1|k,a} of the north-east-up coordinate system by substituting the prediction error covariance matrix V_{k+1|k,a} of the body coordinate system and the drive noise error covariance matrix Qₖ into Expression (88).

The third coordinate transformation unit 6f-n outputs each of the prediction value vector X_{k+1|k,a} of the north-east-up coordinate system and the prediction error covariance matrix P_{k+1|k,a} of the north-east-up coordinate system to the smoothing unit 5.

The second coordinate transformation unit 6e acquires each of the prediction value vector Y_{k+1|k} of the body coordinate system and the prediction error covariance matrix V_{k+1|k} of the body coordinate system from the prediction value integrating unit 6c.

The second coordinate transformation unit 6e transforms the prediction value vector Y_{k+1|k} of the body coordinate system into a prediction value vector X_{k+1|k} of the north-east-up coordinate system in accordance with Expression (91).

The second coordinate transformation unit 6e outputs each of the prediction value vector X_{k+1|k} of the north-east-up coordinate system and the prediction error covariance matrix V_{k+1|k} of the body coordinate system to the third coordinate transformation unit 6g.

The third coordinate transformation unit 6g acquires each of the prediction value vector X_{k+1|k} of the north-east-up coordinate system and the prediction error covariance matrix V_{k+1|k} of the body coordinate system from the second coordinate transformation unit 6e.

The third coordinate transformation unit 6g transforms the prediction error covariance matrix V_{k+1|k} of the body coordinate system into a prediction error covariance matrix P_{k+1|k} of the north-east-up coordinate system by substituting the prediction error covariance matrix V_{k+1|k} of the body coordinate system and the drive noise error covariance matrix Qₖ into Expression (92).

The third coordinate transformation unit 6g outputs the prediction value vector X_{k+1|k} of the north-east-up coordinate system to the tracking gate unit 1.

The third coordinate transformation unit 6g also outputs each of the prediction value vector X_{k+1|k} of the north-east-up coordinate system and the prediction error covariance matrix P_{k+1|k} of the north-east-up coordinate system to the smoothing unit 5.

The tracking gate unit 1 acquires the observation value vector Zₖ which is position observation information indicating a target observation position from a sensor that observes the position of the target.

The tracking gate unit 1 acquires the prediction value vector X_{k+1|k} of the north-east-up coordinate system from the third coordinate transformation unit 6g.

The tracking gate unit 1 determines whether or not the position of the target is present within the tracking gate on the basis of the position vectors xₖ, yₖ, and zₖ included in the observation value vector Zₖ.

If the position of the target is present within the tracking gate (YES in step ST13 in FIG. 8), the tracking gate unit 1 gives a notification indicating that the position of the target is present within the tracking gate to the smoothing unit 5.

If the position of the target is not present within the tracking gate (NO in step ST13 in FIG. 8), the tracking gate unit 1 gives a notification indicating that the position of the target is not present within the tracking gate to the smoothing unit 5.

When receiving the notification indicating that the position of the target is present within the tracking gate from the tracking gate unit 1, the smoothing unit 5 acquires the prediction value vector X_{k+1|k,a} of the north-east-up coordinate system and the prediction error covariance matrix P_{k+1|k,a} of the north-east-up coordinate system from each of the third coordinate transformation units 6f-1 to 6f-N.

The smoothing unit 5 also acquires each of the prediction value vector X_{k+1|k} of the north-east-up coordinate system and the prediction error covariance matrix P_{k+1|k} of the north-east-up coordinate system from the third coordinate transformation unit 6g.

The smoothing unit 5 calculates a smoothed value vector X_{k|k,a} by substituting the observation value vector Zₖ and the prediction value vector X_{k+1|k,a} of the north-east-up coordinate system into Expression (93) (step ST14 in FIG. 8). The prediction value vector X_{k+1|k,a} is substituted into Expression (93) as a prediction value vector X_{k|k-1,a}.

In addition, the smoothing unit 5 calculates a smoothing error covariance matrix P_{k|k,a} by substituting the prediction error covariance matrix P_{k+1|k,a} of the north-east-up coordinate system into Expression (94) (step ST14 in FIG. 8). The prediction error covariance matrix P_{k+1|k,a} is substituted into Expression (94) as the prediction error covariance matrix P_{k|k-1,a}.

The smoothing unit 5 outputs each of the smoothed value vector X_{k|k,a} and the smoothing error covariance matrix P_{k|k,a} to the prediction unit 6.

In addition, the smoothing unit 5 outputs each of the smoothed value vector X_{k|k,a} and the smoothing error covariance matrix P_{k|k,a} to, for example, a display device (not illustrated) or a radar device (not illustrated).

The smoothing unit 5 calculates a prediction value vector Y_{k+1|k} by substituting the prediction value vector X_{k+1|k} into Expression (7), and calculates a smoothed value vector X_{k|k} by substituting the observation value vector Zₖ and the prediction value vector Y_{k+1|k} into Expression (96) (step ST14 in FIG. 8). The prediction value vector Y_{k+1|k} is substituted into Expression (96) as a prediction value vector Y_{k|k-1}.

In addition, the smoothing unit 5 calculates a smoothing error covariance matrix P_{k|k} by substituting the prediction error covariance matrix P_{k+1|k} of the north-east-up coordinate system into Expression (97) (step ST14 in FIG. 8). The prediction error covariance matrix P_{k+1|k} is substituted into Expression (97) as the prediction error covariance matrix P_{k|k,a}.

The smoothing unit 5 outputs each of the smoothed value vector X_{k|k} and the smoothing error covariance matrix P_{k|k} to the prediction unit 6.

In addition, the smoothing unit 5 outputs each of the smoothed value vector X_{k|k} and the smoothing error covariance matrix P_{k|k} to, for example, a display device (not illustrated) or a radar device (not illustrated).

In the target tracking device illustrated in FIG. 5, the smoothing unit 5 outputs each of the smoothed value vector X_{k|k,a} and the smoothed value vector X_{k|k} to a display device or the like. However, this is merely an example, and the smoothing unit 5 may output, for example, an average value of the smoothed value vector X_{k|k,a} and the smoothed value vector X_{k|k} to a display device or the like.

The first coordinate transformation unit 6a acquires each of the smoothed value vector X_{k|k,a} and the smoothing error covariance matrix P_{k|k,a} from the smoothing unit 5.

The first coordinate transformation unit 6a also acquires each of the smoothed value vector X_{k|k} and the smoothing error covariance matrix P_{k|k} from the smoothing unit 5.

The first coordinate transformation unit 6a transforms, in accordance with Expressions (4) to (6), the coordinate system of each of the smoothed value vector X_{k|k,a} and the smoothed value vector X_{k|k} into a body coordinate system as indicated by Expression (3) (step ST15 in FIG. 8).

That is, the first coordinate transformation unit 6a transforms the smoothed value vector X_{k|k,a} of the north-east-up coordinate system into a smoothed value vector Y_{k|k,a} of the body coordinate system, and transforms the smoothed value vector X_{k|k} of the north-east-up coordinate system into a smoothed value vector Y_{k|k} of the body coordinate system.

The first coordinate transformation unit 6a outputs the smoothed value vector Y_{k|k,a} (a=1, . . . , N) of the body coordinate system to the prediction processing unit 6b-n (n=1, . . . , N), and outputs the smoothed value vector Y_{k|k} of the body coordinate system to the prediction value integrating unit 6c.

In addition, the first coordinate transformation unit 6a transforms the coordinate system of each of the smoothing error covariance matrix P_{k|k,a} and the smoothing error covariance matrix P_{k|k} into a body coordinate system in accordance with Expression (30) (step ST15 in FIG. 8).

That is, the first coordinate transformation unit 6a transforms the smoothing error covariance matrix P_{k|k,a} of the north-east-up coordinate system into a smoothing error covariance matrix V_{k|k,a} of the body coordinate system, and transforms the smoothing error covariance matrix P_{k|k} of the north-east-up coordinate system into a smoothing error covariance matrix V_{k|k} of the body coordinate system (step ST15 in FIG. 8).

The first coordinate transformation unit 6a outputs the smoothing error covariance matrix V_{k|k,a} (a=1, . . . , N) of the body coordinate system to the prediction processing unit 6b-n (n=1, . . . , N), and outputs the smoothing error covariance matrix V_{k|k} of the body coordinate system to the prediction value integrating unit 6c.

The prediction processing unit 6b-n (n=1, . . . , N) acquires each of the smoothed value vector Y_{k|k,a} (a32 1, . . . , N) of the body coordinate system and the smoothing error covariance matrix V_{k|k,a} (a=1, . . . , N) of the body coordinate system from the first coordinate transformation unit 6a.

The prediction processing unit 6b-n substitutes the smoothed value vector Y_{k|k,a} of the body coordinate system into Expression (85) as the smoothed value vector Y_{k|k} of the body coordinate system to calculate a prediction value vector Y_{k+1|k,a} of the body coordinate system (step ST16a in FIG. 8). In Expression (85), Y_{k-1|k-1} corresponds to Y_{k|k} , and Y_{k|k-1,a} corresponds to Y_{k+1|k,a}.

In addition, the prediction processing unit 6b-n calculates a prediction error covariance matrix V_{k+1|k,a} of the body coordinate system by substituting the smoothing error covariance matrix V_{k|k,a} of the body coordinate system into Expression (86) as the smoothing error covariance matrix V_{k|k} of the body coordinate system (step ST16a in FIG. 8). In Expression (86), V_{k-1|k-1} corresponds to V_{k|k}, and V_{k|k-1,a} corresponds to V_{k+1|k,a}.

The prediction processing unit 6b-n outputs each of the prediction value vector Y_{k+1|k,a} of the body coordinate system and the prediction error covariance matrix V_{k+1|k,a} of the body coordinate system to the second coordinate transformation unit 6e.

The prediction value integrating unit 6c acquires each of the smoothed value vector Y_{k|k} of the body coordinate system and the smoothing error covariance matrix V_{k|k} of the body coordinate system from the first coordinate transformation unit 6a.

The prediction value integrating unit 6c calculates a prediction value vector Y_{k+1|k} of the body coordinate system by substituting the smoothed value vector Y_{k|k} of the body coordinate system into Expression (89) (step ST16b in FIG. 8). In Expression (89), Y_{k-1|k-1} corresponds to Y_{k|k} , and Y_{k|k-1} corresponds to Y_{k+1|k}.

In addition, the prediction value integrating unit 6c substitutes the smoothing error covariance matrix V_{k|k} of the body coordinate system into Expression (90) to calculate a prediction error covariance matrix V_{k+1|k} of the body coordinate system (step ST16b in FIG. 8). In Expression (90), V_{k-1|k-1} corresponds to V_{k|k} , and V_{k|k-1} corresponds to V_{k+1|k}.

The prediction value integrating unit 6c outputs each of the prediction value vector Y_{k+1|k} of the body coordinate system and the prediction error covariance matrix V_{k+1|k}of the body coordinate system to the second coordinate transformation unit 6d-n.

The second coordinate transformation unit 6d-n (n=1, . . . , N) acquires each of the prediction value vector Y_{k+1|k,a} of the body coordinate system and the prediction error covariance matrix V_{k+1|k,a} of the body coordinate system from the prediction processing unit 6b-n.

The second coordinate transformation unit 6d-n transforms the prediction value vector Y_{k+1|k,a} of the body coordinate system into a prediction value vector X_{k+1|k,a} of the north-east-up coordinate system in accordance with Expression (87) (step ST17 in FIG. 8).

The second coordinate transformation unit 6d-n outputs each of the prediction value vector X_{k+1|k,a} of the north-east-up coordinate system and the prediction error covariance matrix V_{k+1|k,a} of the body coordinate system to the third coordinate transformation unit 6f-n.

The third coordinate transformation unit 6f-n acquires each of the prediction value vector X_{k+1|k,a} of the north-east-up coordinate system and the prediction error covariance matrix V_{k+1|k,a} of the body coordinate system from the second coordinate transformation unit 6d-n.

The third coordinate transformation unit 6f-n transforms the prediction error covariance matrix V_{k+1|k,a} of the body coordinate system into a prediction error covariance matrix P_{k+1|k,a} of the north-east-up coordinate system by substituting the prediction error covariance matrix V_{k+1|k,a} of the body coordinate system and the drive noise error covariance matrix Qₖ into Expression (88) (step ST18 in FIG. 8).

The third coordinate transformation unit 6f-n outputs each of the prediction value vector X_{k+1|k,a} of the north-east-up coordinate system and the prediction error covariance matrix P_{k+1|k,a} of the north-east-up coordinate system to the smoothing unit 5.

The second coordinate transformation unit 6e acquires each of the prediction value vector Y_{k+1|k} of the body coordinate system and the prediction error covariance matrix V_{k+1|k} of the body coordinate system from the prediction value integrating unit 6c.

The second coordinate transformation unit 6e transforms the prediction value vector Y_{k+1|k} of the body coordinate system into a prediction value vector X_{k+1|k} of the north-east-up coordinate system in accordance with Expression (91) (step ST17 in FIG. 8).

The second coordinate transformation unit 6e outputs each of the prediction value vector X_{k+1|k} of the north-east-up coordinate system and the prediction error covariance matrix V_{k+1|k} of the body coordinate system to the third coordinate transformation unit 6g.

The third coordinate transformation unit 6g acquires each of the prediction value vector X_{k+1|k} of the north-east-up coordinate system and the prediction error covariance matrix V_{k+1|k} of the body coordinate system from the second coordinate transformation unit 6e.

The third coordinate transformation unit 6g transforms the prediction error covariance matrix V_{k+1|k} of the body coordinate system into a prediction error covariance matrix P_{k+1|k} of the north-east-up coordinate system by substituting the prediction error covariance matrix V_{k+1|k} of the body coordinate system and the drive noise error covariance matrix Qₖ into Expression (92) (step ST18 in FIG. 8).

The third coordinate transformation unit 6g outputs the prediction value vector X_{k+1|k} of the north-east-up coordinate system to the tracking gate unit 1.

The third coordinate transformation unit 6g also outputs each of the prediction value vector X_{k+1|k} of the north-east-up coordinate system and the prediction error covariance matrix P_{k+1|k} of the north-east-up coordinate system to the smoothing unit 5.

If the end request of the target tracking processing is not given to the target tracking device (NO in step ST19 in FIG. 8), the processes of steps ST13 to ST18 are repeated.

If the end request of the target tracking processing is given to the target tracking device (YES in step ST19 in FIG. 8), a series of the processing performed by the target tracking device ends.

In the second embodiment described above, the prediction unit 6 performs prediction processing based on each of a plurality of motion hypotheses of the target using the initial value of the smoothed value calculated by the initial value calculating unit 2 or the smoothed value estimated by the smoothing unit 5, to thereby calculate a plurality of prediction values. The target tracking device illustrated in FIG. 5 is configured in such a manner that the smoothing unit 5 estimates a smoothed value indicating a smoothed state of the target using the position observation information output from the sensor and each of the prediction values calculated by the prediction unit 6. Therefore, similarly to the target tracking device illustrated in FIG. 1, the target tracking device illustrated in FIG. 5 can suppress degradation of the prediction accuracy due to a large deviation of the initial value of the smoothed value from the original smoothed value, and can enhance the tracking accuracy as compared with the target tracking device illustrated in FIG. 1.

In the target tracking device illustrated in FIG. 5, the smoothing unit 5 outputs N smoothed value vectors X_{k|k,a} and one smoothed value vector X_{k|k} to a display device (not illustrated) or the like. However, this is merely an example, and the smoothing unit 5 may calculate, for example, an average value of the N smoothed value vectors X_{k|k,a} and one smoothed value vector X_{k|k} or a weighted addition value of the N smoothed value vectors X_{k|k,a} and one smoothed value vector X_{k|k}, and output the average value or the weighted addition value to a display device (not illustrated) or the like.

It is to be noted that, in the present disclosure, two or more of the above embodiments can be freely combined, or any component in the embodiments can be modified or omitted.

### INDUSTRIAL APPLICABILITY

The present disclosure is suitable for a target tracking device and a target tracking method.

### REFERENCE SIGNS LIST

1: tracking gate unit, 2: initial value calculating unit, 3: smoothing unit, 4: prediction unit, 4a: first coordinate transformation unit, 4b: prediction processing unit, 4c: second coordinate transformation unit, 4d: third coordinate transformation unit, 5: smoothing unit, 6: prediction unit, 6a: first coordinate transformation unit, 6b-1 to 6b-N: prediction processing unit, 6c: prediction value integrating unit, 6d-1 to 6d-N, 6e: second coordinate transformation unit, 6f-1 to 6f-N, 6g: third coordinate transformation unit, 11: tracking gate circuit, 12: initial value calculating circuit, 13: smoothing circuit, 14: prediction circuit, 15: smoothing circuit, 16: prediction circuit, 21: memory, 22: processor

1. A target tracking device comprising:
a processor; and
a memory storing a program, upon executed by the processor, to perform a process:
to acquire position observation information indicating target observation positions at two different sampling times from a sensor that observes a position of a target, and calculate an initial value of a smoothed value including a position vector of the target and a velocity vector of the target as an initial value of a smoothed value indicating a state of the target on a basis of the position observation information;
to perform estimation processing of estimating the smoothed value indicating the state of the target using the position observation information output from the sensor and a prediction value indicating the state of the target; and
to predict a future state of the target using the initial value of the smoothed value calculated or a smoothed value estimated, and output a prediction value indicating a result of predicting the future state of the target as a prediction value to be used for next estimation processing,
wherein
the process includes:
to transform a coordinate system of the initial value of the smoothed value calculated or a coordinate system of the smoothed value estimated into a body coordinate system of the target;
to predict a future state of the target using an initial value of the body coordinate system that has been transformed or a smoothed value of the body coordinate system that has been transformed, and output a prediction value indicating a prediction result of predicting the future state of the target; and
to transform a coordinate system of the prediction value output into a north- east-up coordinate system, and
the process
acquires, as a prediction value to be used for next estimation processing, a prediction value of the north-east-up coordinate system that has been transformed, and performs estimation processing of estimating a smoothed value indicating the state of the target using the position observation information output from the sensor and the prediction value of the north-east-up coordinate system.

2. The target tracking device according to claim 1, wherein
the process
estimates a smoothed value including a position vector of the target, a velocity vector of the target, and an aerodynamic coefficient of the target as the smoothed value indicating the state of the target using the position observation information output from the sensor and a prediction value predicted last time, and
the process
calculates a prediction value including the position vector of the target, the velocity vector of the target, and the aerodynamic coefficient of the target as a prediction value indicating the result of predicting the future state of the target by using the initial value of the smoothed value calculated or the smoothed value estimated.

3. The target tracking device according to claim 1, wherein
the process
performs estimation processing of estimating a smoothed value indicating the state of the target using the position observation information output from the sensor, the prediction value output, and a prediction error covariance matrix, calculates a smoothing error covariance matrix on a basis of the prediction error covariance matrix,
calculates a prediction error covariance matrix using the smoothing error covariance matrix calculated and a drive noise error covariance matrix, and outputs the prediction error covariance matrix as a prediction error covariance matrix used for next estimation processing.

4. The target tracking device according to claim 1, the process further comprising to output the position observation information only when a target observation position indicated by the position observation information output from the sensor is present within a tracking gate.

5. The target tracking device according to claim 1, wherein
the process
performs prediction processing based on each of a plurality of motion hypotheses of the target using the initial value of the smoothed value calculated or the smoothed value estimated to calculate a plurality of prediction values, and
the process
performs estimation processing of estimating a smoothed value indicating the state of the target using the position observation information output from the sensor and each of the prediction values calculated.

6. The target tracking device according to claim 5, wherein
the process
performs prediction processing based on the plurality of motion hypotheses in addition to the prediction processing based on each of the motion hypotheses to calculate a prediction value, and outputs a prediction value related to the plurality of motion hypotheses in addition to the plurality of prediction values related to each of the motion hypotheses.

7. A target tracking method comprising:
acquiring position observation information indicating target observation positions at two different sampling times from a sensor that observes a position of a target, and calculating an initial value of a smoothed value including a position vector of the target and a velocity vector of the target as an initial value of a smoothed value indicating a state of the target on a basis of the position observation information;
performing estimation processing of estimating a smoothed value indicating the state of the target using the position observation information output from the sensor and a prediction value indicating the state of the target; and
predicting a future state of the target using the initial value of the smoothed value calculated or the smoothed value estimated, and outputting a prediction value indicating a result of predicting the future state of the target as a prediction value to be used for next estimation processing,
wherein
the method includes:
transforming a coordinate system of the initial value of the smoothed value calculated or a coordinate system of the smoothed value estimated into a body coordinate system of the target;
predicting a future state of the target using an initial value of the body coordinate system that has been transformed or a smoothed value of the body coordinate system that has been transformed, and outputting a prediction value indicating a prediction result of predicting the future state of the target; and
transforming a coordinate system of the prediction value output into a north- east-up coordinate system, and
the method further includes:
acquiring, as a prediction value to be used for next estimation processing, a prediction value of the north-east-up coordinate system that has been transformed, and performing estimation processing of estimating a smoothed value indicating the state of the target using the position observation information output from the sensor and the prediction value of the north-east-up coordinate system.
